SEQUENCE LISTING (4 sequences)

SEQ ID NO: 1 - DNA, 29 bp, Artificial Sequence
  Description of Artificial Sequence Synthetic primer
agcggataactgccagctcagcagcccgt

SEQ ID NO: 2 - DNA, 29 bp, Artificial Sequence
  Description of Artificial Sequence Synthetic primer
agcggataactgccagctcagcagcccag

SEQ ID NO: 3 - DNA, 30 bp, Artificial Sequence
  Description of Artificial Sequence Synthetic primer
agcggataactgaggctgtggctgaacagg

SEQ ID NO: 4 - DNA, 16 bp, Artificial Sequence
  Description of Artificial Sequence Synthetic primer
cagccaaacctccctc

(19) United States
(12) Patent Application Publication
(10) Pub. No.: US 2008/0096766 A1
(43) Pub. Date: Apr. 24, 2008

(54) METHODS AND COMPOSITIONS FOR THE AMPLIFICATION, DETECTION AND QUANTIFICATION OF NUCLEIC ACID FROM A SAMPLE

(75) Inventor: Min Seob LEE, San Diego, CA (US)

Correspondence Address: GRANT ANDERSON LLP;C/O PORTFOLIOIP, PO BOX 52050, MINNEAPOLIS, MN, 55402, US

(73) Assignee: Sequenom, Inc., San Diego, CA (US)

(21) Appl. No.: 11/763,211

(22) Filed: Jun. 14, 2007

Related U.S. Application Data
(60) Provisional application No. 60/805,073, filed on Jun. 16, 2006.

(51) Int. Cl. C40B 20/08

(52) U.S. Cl. 506/6

(57) ABSTRACT

The invention relates to methods and kits for the amplification, detection and quantification of a nucleic acid from a sample. The methods of the invention may be used in a wide range of applications, including, but not limited to, the detection and quantification of fetal nucleic acid from maternal plasma, the detection and quantification of circulating nucleic acids from neoplasms (malignant or non-malignant), accurate pooling analysis for low frequency alleles, or any other application requiring sensitive quantitative analysis of nucleic acids.

### RELATED PATENT APPLICATION

This patent application claims the benefit of U.S. provisional patent application No. 60/805,073, filed Jun. 16, 2006, naming Min Seob Lee as an inventor, entitled METHODS AND COMPOSITIONS FOR THE AMPLIFICATION, DETECTION AND QUANTIFICATION OF NUCLEIC ACID FROM A SAMPLE, and having attorney docket no. SEQ-6002-PV. The entirety of this provisional patent application is incorporated herein, including all text and drawings.

### FIELD OF THE INVENTION

The invention relates to methods and kits for the amplification, detection and/or quantification of a nucleic acid from a sample. The methods of the invention may be used in a wide range of applications, including, but not limited to, the detection and quantification of fetal nucleic acid from maternal plasma, the detection and quantification of circulating nucleic acids from neoplasms (malignant or non-malignant), accurate pooling analysis for low frequency alleles, or any other application requiring sensitive quantitative analysis of nucleic acids.

### BACKGROUND

The amplification, detection and subsequent quantitative analysis of nucleic acids play a central role in molecular biology, including the diagnosis and prognosis of diseases or disorders. There are many methods known for detecting nucleic acids, including the detection of nucleic acids based on sequence differences among different species of nucleic acid. See, for example, Nelson, Crit Rev Clin Lab Sci. 1998 September; 35(5):369-414, for a review of known methods. However, the ability to detect and accurately quantify nucleic acids, especially low copy number nucleic acids in the presence of other high copy number nucleic acid species, have proven difficult.

### SUMMARY OF THE INVENTION

A shortcoming in the field of nucleic acid detection is the availability of detection methods that allow for the sensitive detection and quantification of low copy number nucleic acid. Low copy number nucleic acid can be highly informative in a wide range of applications, including, but not limited to, non-invasive prenatal testing, cancer diagnostics and low frequency mutation detection. Therefore, the present invention provides improved methods for amplifying and subsequently detecting and analyzing low copy number nucleic acids that were previously undetectable, or detectable with great difficulty and/or unreliability, at sufficient levels to be reliably informative, for example, in a clinical environment. In an application of this improved technology, the invention has led to the possibility of more sensitive, and less invasive, methods for detecting and quantifying fetal nucleic acid in prenatal testing, for example.

Thus, in one aspect, the invention relates to methods and kits for the biased allele-specific (BAS) amplification of a low copy number nucleic acid species based on, preferably, sequence-specific properties of the species, wherein a primer specific for the low copy number species is introduced at increased concentrations, relative to a primer for a high copy number species, to selectively amplify the species to levels suitable for accurate detection and quantification. The present invention, therefore, provides methods for preferentially amplifying a low copy number nucleic acid species relative to high copy number nucleic acid species and quantifying the relative concentrations of the two species. In some embodiments, two or more of the primers may be added at the same time, or at different times in other embodiments (e.g., the first primer before the second primer or the second primer before the first primer). Primers also may be added to the same vessel in some embodiments or to different vessels in certain embodiments.

More specifically, the present invention in part provides a method for amplifying a nucleic acid in a sample, the sample containing at least a first and a second nucleic acid species, wherein the first species has a higher copy number than the second species, comprising the steps of a) in a reaction vessel annealing to the first nucleic acid species a first amplification primer that is substantially specific for the first nucleic acid species, wherein the first primer pair has a first concentration; b) in the reaction vessel annealing to the second nucleic acid species a second amplification primer that is substantially specific for the second nucleic acid species, wherein the second primer has a second concentration and wherein the second concentration of the second amplification primer is greater than the first concentration of the first amplification primer; c) in the reaction vessel annealing to the first and to the second nucleic acid species another amplification primer that can be common to the first and second nucleic acid species, and that is substantially specific for the first and second nucleic acid species; and d) in the reaction vessel performing a nucleic acid amplification reaction, whereby the quantity of the amplification product of the second nucleic acid species is increased relative to the quantity of the amplification product of the first nucleic acid species. “Another amplification primer” in step (c) may be one or more primers. In embodiments involving the use of one additional primer, for example, the primer can specifically hybridize to a nucleotide sequence common to both the first nucleic acid and second nucleic acid. In embodiments involving the use of two additional primers, for example, one additional primer can specifically hybridize to the first nucleic acid and a second additional primer can specifically hybridize to the second nucleic acid.

In an embodiment of the invention, the method of amplification may include, but is not limited to including, a polymerase chain reaction, self-sustained sequence reaction, ligase chain reaction, rapid amplification of cDNA ends, polymerase chain reaction and ligase chain reaction, Q-beta phage amplification, strand displacement amplification, or splice overlap extension polymerase chain reaction. In a preferred embodiment, the method of amplification is PCR. In another embodiment of the invention, the amplification method utilizes a template-dependent polymerase as described in U.S. patent application publication 20050287592, which is hereby incorporated by reference.

In another embodiment, the invention provides an amplification method as described herein which further comprises the step of detecting the amplification product of the first nucleic acid species alone, the second species alone, or both the first and second species together. In another embodiment, the invention provides an amplification method as described herein which further comprises the steps of a) of detecting the amplification product of the first nucleic acid species; and b) detecting the amplification product of the second nucleic acid species; and c) comparing the identity of the first nucleic acid species to the identity of the second nucleic acid species. In a related embodiment, the detection is performed by mass spectrometry.

In another embodiment, the invention provides an amplification method as described herein which further comprises the steps of: a) of quantifying the amplification product of the first nucleic acid species; and b) quantifying the amplification product of the second nucleic acid species; and c) comparing the quantity of the amplification product of the first nucleic acid species to the quantity of the amplification product of the second nucleic acid species. In a related embodiment, the quantification is performed by mass spectrometry. In a preferred embodiment, the first nucleic acid species is of maternal origin and the second nucleic acid species is of fetal origin.

In another aspect, a method is provided for identifying a low copy number nucleic acid species in a sample containing at least a first and second species, wherein the species are amplified in two separate reaction vessels. More specifically the invention provides a method for amplifying a nucleic acid in a sample, the sample containing at least a first and a second nucleic acid species, wherein one of the species has a higher copy number than the other species, comprising the steps of a) in a first reaction vessel, annealing to the first nucleic acid species a first amplification primer that is substantially specific for the first nucleic acid species, wherein the first primer has a first concentration; b) in the first reaction vessel annealing to the second nucleic acid species a second amplification primer that is substantially specific for the second nucleic acid species, wherein the second primer has a second concentration and wherein the second concentration of the second amplification primer is greater than the first concentration of the first amplification primer; c) in the first reaction vessel annealing to the first and to the second nucleic acid species another amplification primer that can be common to the first and second nucleic acid species, and that is substantially specific to the first and second nucleic acid species, and performing a nucleic acid amplification reaction, whereby if the first species has the higher copy number, then the amplification product of the second nucleic acid species is increased relative to the amplification product of the first nucleic acid species; d) in a second reaction vessel annealing to the first nucleic acid species the first amplification primer, wherein the first amplification primer is present at the same concentration as the second concentration of step b; e) in the second reaction vessel annealing to the second nucleic acid species the second amplification primer, wherein the second amplification primer is present at the same concentration as the first concentration of step a, whereby the concentration of the first amplification primer is greater than the concentration of the second amplification primer; and f) in the second reaction vessel annealing to the first and to the second nucleic acid species another amplification primer, which can be common to the first and second nucleic acid species, and performing a nucleic acid amplification reaction, whereby if the second species has the higher copy number, then the amplification product of the first nucleic acid species is increased relative to the amplification product of the second nucleic acid species.

In an embodiment of the invention, the two vessel amplification method further comprises the step of detecting the amplification product of the first nucleic acid species. In another embodiment, the method further comprises the step of detecting the amplification product of the second nucleic acid species. In yet another embodiment, the method further comprises detecting the first nucleic acid species and the second nucleic acid species together, and comparing the identities of the first and second nucleic acid species. In another embodiment, the method further comprises quantifying the amplification product of the first nucleic acid species, quantifying the amplification product of the second nucleic acid species, and comparing the quantity of the amplification product of the first nucleic acid species to the quantity of the amplification product of the second nucleic acid species.

In another aspect, the invention provides a method for determining a suitable, or optimal, ratio of high-copy-number primer to low-copy-number primer. See Example 1 below.

In a related embodiment, the invention provides a method for determining a first PCR primer concentration sufficient to preferentially amplify a low copy number nucleic acid species as described in Example 1. The methods of the present invention may be used to preferentially amplify, and thus detect and quantify, different nucleic acid species based on nucleic acid-based differences (or alleles) between the species. In some embodiments, the present invention is used to detect mutations, and chromosomal abnormalities including but not limited to translocation, transversion, monosomy, trisomy, and other aneuploidies, deletion, addition, amplification, fragment, translocation, and rearrangement. Numerous abnormalities can be detected simultaneously. The present invention also provides a non-invasive method to determine the sequence of fetal DNA from a sample of a pregnant female. The present invention can be used to detect any alteration in gene sequence as compared to the wild type sequence including but not limited to point mutation, reading frame shift, transition, transversion, addition, insertion, deletion, addition-deletion, frame-shift, missense, reverse mutation, and microsatellite alteration. In a preferred embodiment, the nucleic acid-based difference is a single nucleotide polymorphism (SNP). In certain preferred embodiments, the nucleic acid-based difference is a characteristic methylation state. For example, the first nucleic acid species has a first nucleic acid-base methylation pattern and the second nucleic acid species has a second nucleic acid-base methylation pattern, and the first nucleic acid-base methylation pattern differs from the second nucleic acid-base methylation pattern. In some embodiments, the first and second primers are methylation-specific amplification primers.

In a preferred embodiment, more than one nucleic acid-based difference is detected simultaneously in a single, multiplexed reaction. In certain embodiments, alleles of multiple loci of interest are sequenced and their relative amounts quantified and compared. In one embodiment, the sequence of alleles of one to tens to hundreds to thousands of loci of interest on a single chromosome on template DNA is determined. In another embodiment, the sequence of alleles of one to tens to hundreds to thousands of loci of interest on multiple chromosomes is detected and quantified. For example, multiple SNPs (e.g., 2 to about 100 SNPs) may be detected in a single reaction.

In another embodiment, the first and second nucleic acid species comprise different alleles. For example, in the case of a nucleic acid species of maternal origin and a nucleic acid species of fetal origin, the maternal nucleic acid is homozygous for a given allele and the fetal nucleic acid is heterozygous for that same allele. Thus, the present invention provides methods for amplifying, detecting and subsequently quantifying the relative amount of the alleles at a heterozygous locus of interest, where the heterozygous locus of interest was previously identified by determining the sequence of alleles at a locus of interest from template DNA.

The methods of the present invention may be used to amplify, detect or quantify low copy number nucleic acid species relative to a high copy number nucleic acid species. In a preferred embodiment, the starting relative percentage of low copy number nucleic acid species to high copy number nucleic acid species in a sample is 0.5% to 49%. In a related embodiment, the final relative percentage of low copy number nucleic acid species to high copy number nucleic acid species is 5.0% to 80% or more.

The methods of the present invention may be used to amplify, detect or quantify short, fragmented nucleic acid from about 20 bases or greater. It is more preferably from about 50 bases or greater.

The present invention relates in part to amplifying, detecting or quantifying nucleic acids such as DNA, RNA, mRNA, oligonucleosomal, mitochondrial, epigenetically modified, single-stranded, double-stranded, circular, plasmid, cosmid, yeast artificial chromosomes, artificial or man-made DNA, including unique DNA sequences, and DNA that has been reverse transcribed from an RNA sample, such as cDNA, and combinations thereof. In a preferred embodiment, the nucleic acid is cell-free nucleic acid. In another embodiment, the nucleic acid is derived from apoptotic cells. In another embodiment, one species of nucleic acid is of fetal origin, and the other species of nucleic acid is of maternal origin.

The present invention relates to amplifying, detecting or quantifying nucleic acid from a sample such as whole blood, serum, plasma, umbilical cord blood, chorionic villi, amniotic fluid, cerbrospinal fluid, spinal fluid, lavage fluid (e.g., bronchoalveolar, gastric, peritoneal, ductal, ear, athroscopic) biopsy sample, urine, feces, sputum, saliva, nasal mucous, prostate fluid, semen, lymphatic fluid, bile, tears, sweat, breast milk, breast fluid, embryonic cells and fetal cells. In a preferred embodiment, the biological sample is plasma. In another preferred embodiment, the sample is cell free or substantially cell free. In a related embodiment, the sample is a sample of previously extracted nucleic acids. In another embodiment, the sample is a sample of pooled nucleic acids.

The present invention is particularly useful for amplifying, detecting or quantifying fetal nucleic acid from maternal plasma. In a preferred embodiment, the sample is from an animal, most preferably a human. In another preferred embodiment, the sample is from a pregnant human. In a related embodiment, the sample is collected from a pregnant human after the fifth week of gestation. In another embodiment, the pregnant human has an elevated concentration of free fetal nucleic acid in her blood, plasma or amniotic fluid.

The methods provided herein may be used with any known method for detection and quantification of nucleic acids, including primer extension (e.g., iPLEX™, Sequenom Inc.), DNA sequencing, real-time PCR (RT-PCR), restriction fragment length polymorphism (RFLP analysis), allele specific oligonucleotide (ASO) analysis, methylation-specific PCR (MSPCR), pyrosequencing analysis, acycloprime analysis, Reverse dot blot, GeneChip microarrays, Dynamic allele-specific hybridization (DASH), Peptide nucleic acid (PNA) and locked nucleic acids (LNA) probes, TaqMan, Molecular Beacons, Intercalating dye, FRET primers, AlphaScreen, SNPstream, genetic bit analysis (GBA), Multiplex minisequencing, SNaPshot, GOOD assay, Microarray miniseq, arrayed primer extension (APEX), Microarray primer extension, Tag arrays, Coded microspheres, Template-directed incorporation (TDI), fluorescence polarization, Colorimetric oligonucleotide ligation assay (OLA), Sequence-coded OLA, Microarray ligation, Ligase chain reaction, Padlock probes, and Invader assay, or combinations thereof. See also, U.S. Pat. Nos. 6,258,538, 6,277,673, 6,221,601, 6,300,076, 6,268,144, 6,221,605, 6,602,662 and 6,500,621, which are all hereby incorporated by reference.

The methods provided herein may also be modified to introduce additional steps, for example, in order to improve the amplification or detection nucleic acid or improve analysis of target nucleic acid following amplification. For example, the amplification of the high copy number nucleic acid species may be additionally suppressed by methods known in the art. See, for example, Nasis et al. Clinical Chemistry 50: 694-701, 2004. The methods provided herein may also be modified to combine steps, for example, in order to improve automation.

In another embodiment, the methods provided herein may be performed prior to, subsequent to, or simultaneously with another method for extracting nucleic acid such as electrophoresis, liquid chromatography, size exclusion, filtration, microdialysis, electrodialysis, centrifugal membrane exclusion, organic or inorganic extraction, affinity chromatography, PCR, genome-wide PCR, sequence-specific PCR, methylation-specific PCR, introducing a silica membrane or molecular sieve, and fragment selective amplification, for example.

The present invention also further relates to a kit comprising reagents for performing the methods described herein.

### BRIEF DESCRIPTION OF THE DRAWINGS

FIG. 1 shows standard allele-specific PCR amplification methods, which have very low discriminatory power for detecting and quantifying low copy number nucleic acid compared to high copy number nucleic acid. By selectively increasing the low copy number primer concentration relative to the high copy number primer concentration, the biased allele specific (BAS) amplification of the present invention can significantly increase the discriminatory power by enhancing low copy number molecule amplification and detection while suppressing high copy number molecule amplification and detection.

FIG. 2 shows an example of an assay design strategy for biased allele specific (BAS) amplification to detect and measure single nucleotide or insertion/deletion polymorphisms using the MassArray® system. The allele-specific primers are designed to be complementary to a specific allele at or near 3′ termini of primers. In an embodiment of the invention, the allele-specific primer is complementary to a specific allele at a nucleotide about 5 or fewer nucleotide positions 5′ of the 3′ terminus of a primer. In certain embodiments, the allele-specific primer is complementary to a specific allele at a nucleotide 4, 3, 2 or 1 nucleotide positions 5′ of the 3′ terminus of a primer. In another embodiment, the allele-specific primer is complementary to a specific allele at the 3′ terminus of a primer. A common primer is substantially complementary to the sequences of the nucleic acid species that are identical to both templates. The detection extension probe can be placed on the opposite side of polymorphism site (a) or at another sequence difference on the amplicon that can distinguish the two alleles (b). Also, in the Figure the + icon indicates the relative concentration of primer and template, where +++ is a higher concentration than +.

FIG. 3 shows an example of two detection scenarios (Case 1 and Case 2). Standard PCR yields a poor discrimination, whereas BAS amplification yields a 50% reduction of the second peak. The BAS strategy not only reliably detects the fetus-specific allele (T), but also accurately measure the different ratio compared to the maternal allele.

The primers used for Case 2 in FIG. 3 are provided below in Table A.

TABLE A

| | | |
|---|---|---|
| X1-S | AGCGGATAACTGCCAGCTCAGCAGCCCGT | Allele Specific Primer for AMG_X |
| | | Gene |
| Y1-S | AGCGGATAACTGCCAGCTCAGCAGCCCAG | Allele Specific Primer for AMG_Y |
| | | Gene |
| X1-L | AGCGGATAACTGAGGCTGTGGCTGAACAGG | Common Primer for AMG X & Y |
| XY1-E | CAGCCAAACCTCCCTC | Extend Probe for AMG X & Y |

FIGS. 4A to 4F show spectrograms, where the BAS primers are variable (for example at 1:10 ratio in FIG. 4D) and the target DNA is fixed at a ratio of 98:2 (female:male).

FIG. 5 is a graph showing the results of the same experiment run twice, wherein the BAS primers are variable (for example at 1:10 ratio in FIG. 4D) and the target DNA is fixed at a ratio of 98:2 (female:male).

FIGS. 6A to 6F show spectrograms, where the BAS primers are fixed (at 1:5 ratio) and the target DNA is variable (for example at 99:1 female:male in FIG. 6B).

FIG. 7 is a graph showing the results of the same experiment run twice, wherein the BAS primers are fixed (at 1:5 ratio) and the target DNA is variable.

FIG. 8A shows an aneuploidy detection assay design, wherein the mother has a CC genotype and the fetus has a CTT or CCT trisomy genotype. The genotypes are present in the following ratios:

| | |
|---|---|
| CT | 97.5:2.5 |
| CTT | 96.7:3.4 |
| CCT | 98.4:1.7 |

FIG. 8B shows how BAS amplification allows for the suppression of the high copy species amplification, while the low copy species amplification is augmented to detectable levels.

FIGS. 9-12 show different scenarios with different genotype combinations between the mother and the fetus. The “swab” shows nucleic acid solely of maternal origin, while the “plasma” contains both maternal and fetal nucleic acid. As used herein, “swab” indicates any nucleic sample source that is free of fetal nucleic acid, such maternal cells, for example.

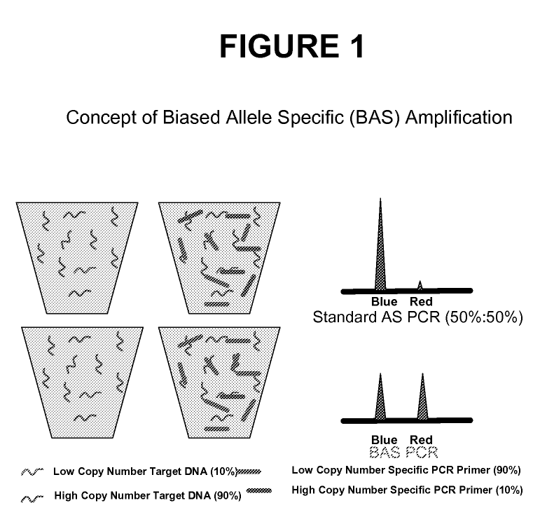

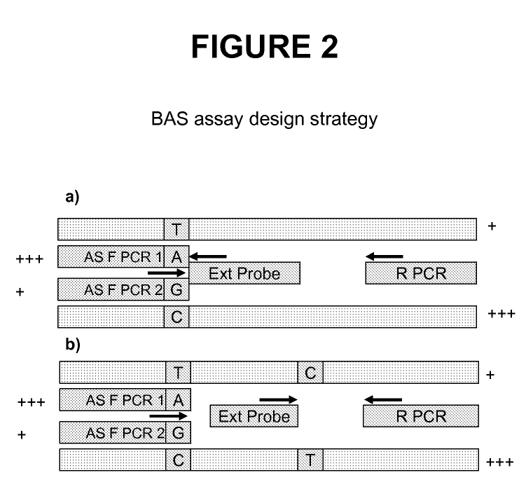

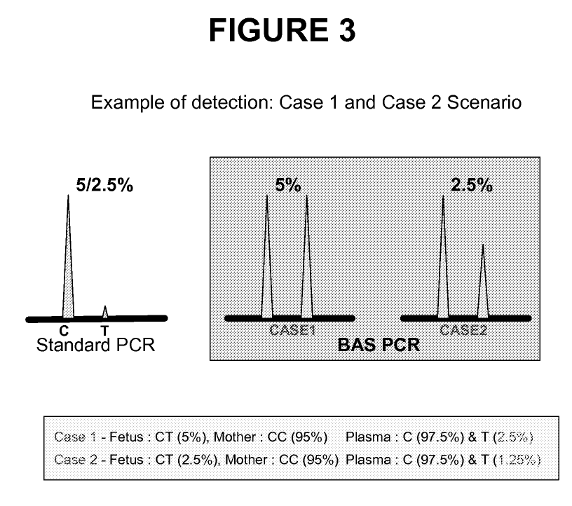

### DETAILED DESCRIPTION OF THE INVENTION

The present invention includes methods to amplify, detect and/or analyze nucleic acids, and is particularly useful for the amplification, detection and quantification of cell-free, low copy number nucleic acid in the presence of high copy number nucleic acid (e.g., host or maternal nucleic acids). In particular, in some embodiments, the methods of the present invention may be carried out nucleic acids which are obtained from extracellular sources. The presence of cell-free nucleic acid in peripheral blood is a well established phenomenon. While cell-free nucleic acid may originate from several sources, it has been demonstrated that one source of circulating extracellular nucleic acid originates from programmed cell death, also known as apoptosis. The source of nucleic acid that arise as a result of apoptosis may be found in many body fluids and originate from several sources, including, but not limited to, normal programmed cell death in the host, induced programmed cell death in the case of an autoimmune disease, septic shock, neoplasms (malignant or non-malignant), or non-host sources such as an allograft (transplanted tissue), or the fetus or placenta of a pregnant woman. The applications for the amplification, detection, and analysis of extracellular nucleic acid from peripheral blood or other body fluids are widespread and may include inter alia, non-invasive prenatal diagnosis, cancer diagnostics, pathogen detection, auto-immune response and allograft rejection.

The term “low copy number” nucleic acid or primer as used herein means a nucleic acid species which is present in a smaller amount than another nucleic acid species. By smaller amount is meant, preferably, a lower concentration, but could mean a smaller number of molecules, a lesser amount on a weight by weight basis or the like. A low copy number nucleic acid may be quantified in terms of a ratio, such as a ratio of low copy number nucleic acid to higher copy number nucleic acid or a ratio of low copy number nucleic acid to total nucleic acid, for example. A low copy number nucleic acid also may be quantified as an amount, such as by copy number (e.g., about one, about two, about three, about four, about five, about ten copies) or by grams, moles or concentration (e.g., about 0.001 ng to about 1 ng, or about 0.001 ng to about 0.1 ng, about 0.001 ng to about 0.01 ng).

The term “high copy number” nucleic acid or primer as used herein means a nucleic acid species which is present in a larger amount than another nucleic acid species. By larger amount is meant, preferably, a higher concentration, but could mean a greater number of molecules, a greater amount on a weight by weight basis or the like.

The terms low copy number and high copy number nucleic acid or primer may also mean that relative to each other one has a lower concentration, but could mean a smaller number of molecules, a lesser amount on a weight by weight basis or the like, than the other.

The term “host cell” as used herein is any cell into which exogenous nucleic acid can be introduced, producing a host cell which contains exogenous nucleic acid, in addition to host cell nucleic acid. As used herein the terms “host cell nucleic acid” and “endogenous nucleic acid” refer to nucleic acid species (e.g., genomic or chromosomal nucleic acid) that are present in a host cell as the cell is obtained. As used herein, the term “exogenous” refers to nucleic acid other than host cell nucleic acid; exogenous nucleic acid can be present into a host cell as a result of being introduced in the host cell or being introduced into an ancestor of the host cell. Thus, for example, a nucleic acid species which is exogenous to a particular host cell is a nucleic acid species which is non-endogenous (not present in the host cell as it was obtained or an ancestor of the host cell). Appropriate host cells include, but are not limited to, bacterial cells, yeast cells, plant cells and mammalian cells.

The terms “nucleic acid” and “nucleic acid molecule” may be used interchangeably throughout the disclosure. The terms refer to a deoxyribonucleotide (DNA), ribonucleotide polymer (RNA), RNA/DNA hybrids and polyamide nucleic acids (PNAs) in either single- or double-stranded form, and unless otherwise limited, would encompass known analogs of natural nucleotides that can function in a similar manner as naturally occurring nucleotides.

The term “nucleic acid species” as used herein refers to the nucleic acid of interest in a sample. A nucleic acid species may differ from another nucleic acid species based on nucleic acid differences, including, but not limited to, mutations, insertions, deletions, unique nucleotide sequences from different organisms, or fetal versus maternal source. In a related embodiment, the nucleic acid species is from apoptotic DNA, fetal DNA, oncogenic DNA, or any non-host DNA. In another related embodiment, the nucleic acid species is cell-free nucleic acid. In another related embodiment, the nucleic acid species is oligonucleosomal nucleic acid generated during programmed cell death. Different nucleic acid species may be different alleles, where each allele has a different sequence at one or more loci (the term “allele” is described in greater detail hereafter).

The terms “locus,” “loci” and “locus of interest” as used herein refer to a selected region of nucleic acid that is within a larger region of nucleic acid. A locus of interest can include but is not limited to 1-100, 1-50, 1-20, or 1-10 nucleotides, sometimes 1-6, 1-5, 14, 1-3, 1-2, or 1 nucleotide(s).

The term “allele” as used herein is one of several alternate forms of a gene or non-coding regions of DNA that occupy the same position on a chromosome. The term allele can be used to describe DNA from any organism including but not limited to bacteria, viruses, fungi, protozoa, molds, yeasts, plants, humans, non-humans, animals, and archeabacteria.

Alleles can have the identical sequence or can vary by a single nucleotide or more than one nucleotide. With regard to organisms that have two copies of each chromosome, if both chromosomes have the same allele, the condition is referred to as homozygous. If the alleles at the two chromosomes are different, the condition is referred to as heterozygous. For example, if the locus of interest is SNP X on chromosome 1, and the maternal chromosome contains an adenine at SNP X (A allele) and the paternal chromosome contains a guanine at SNP X (G allele), the individual is heterozygous at SNP X.

The terms “quantitate” and “quantify,” and grammatical variants thereof, are used interchangeably herein.

The term “identity” as used herein, means the sequence of one nucleotide, or more than one contiguous nucleotides, in a polynucleotide. In the case of a single nucleotide, e.g., a SNP, “sequence” and “identity” are used interchangeably herein. In the case of a characteristic methylation state, the identity refers to the methylation status of a particular CpG island. See for example, US Application 20050272070, which is hereby incorporated by reference.

The term “template” as used herein refers to any nucleic acid molecule that can be used for amplification in the invention. The template nucleic acid can be obtained from any biological or non-biological source.

As used herein, a “primer” refers to an oligonucleotide that is suitable for hybridizing, chain extension, amplification and sequencing. Similarly, a probe is a primer used for hybridization. The primer refers to a nucleic acid that is of low enough mass, typically about between about 5 and 200 nucleotides, generally about 70 nucleotides or less than 70, and of sufficient size to be conveniently used in the methods of amplification and methods of detection and sequencing provided herein. These primers include, but are not limited to, primers for detection and sequencing of nucleic acids, which require a sufficient number nucleotides to form a stable duplex, typically about 6-30 nucleotides, about 10-25 nucleotides and/or about 12-20 nucleotides. Thus, for purposes herein, a primer is a sequence of nucleotides contains of any suitable length, typically containing about 6-70 nucleotides, 12-70 nucleotides or greater than about 14 to an upper limit of about 70 nucleotides, depending upon sequence and application of the primer

The term “methylation specific primer” as used herein refers to a primer that specifically hybridizes to a sequence having a particular methylation state over another methylation state. Nucleotide sequences can be methylated, and a particular nucleotide sequence may have different methylation states. Methylation specific primers are known to, and can be selected by, the person of ordinary skill in the art (e.g., U.S. patent application Ser. No. 10/346,514, which published Nov. 13, 2003 as Application Publication No. 20030211522).

As used herein, “specifically hybridizes” refers to hybridization of a probe or primer to a target sequence preferentially to a non-target sequence. Those of skill in the art are familiar with parameters that affect hybridization, such as temperature, probe or primer length and composition, buffer composition and salt concentration and can readily adjust these parameters to achieve specific hybridization of a nucleic acid to a target sequence. Preferential hybridization to a target sequence includes little or no detectable hybridization to the non-target sequence, for example.

In certain embodiments of the invention, the sample may include, but is not limited to, whole blood, serum, plasma, umbilical cord blood, chorionic villi, amniotic fluid, cerbrospinal fluid, spinal fluid, lavage fluid (e.g., bronchoalveolar, gastric, peritoneal, ductal, ear, athroscopic), biopsy sample, tissue, urine, feces, sputum, saliva, nasal mucous, prostate fluid, semen, lymphatic fluid, bile, tears, vaginal secretion, sweat, breast milk, breast fluid, embryonic cells and fetal cells. As used herein, the term “blood” encompasses whole blood or any fractions of blood, such as serum and plasma as conventionally defined. Blood plasma refers to the fraction of whole blood resulting from centrifugation of blood treated with anticoagulants. Blood serum refers to the watery portion of fluid remaining after a blood sample has coagulated. In a preferred embodiment, the sample is blood, serum or plasma. Thus, in certain embodiments, template DNA is isolated from serum, while in other embodiments template DNA is isolated from plasma. In certain preferred embodiments, the sample is cell free or substantially cell-free. In a related embodiment, the sample is a sample containing previously extracted, isolated or purified nucleic acids. One way of targeting a nucleic acid species is to use the non-cellular fraction of a biological sample; thus limiting the amount of intact cellular material (e.g., large strand genomic DNA) from contaminating the sample. In an embodiment of the invention, a cell-free sample such as pre-cleared plasma, urine, and the like is first treated to inactivate intracellular nucleases through the addition of an enzyme, a chaotropic substance, a detergent or any combination thereof. In some embodiments, the sample is first treated to remove substantially all cells from the sample by any of the methods known in the art, for example, centrifugation, filtration, affinity chromatography, and the like.

Fetal nucleic acid is present in maternal plasma from the first trimester onwards, with concentrations that increase with progressing gestational age (Lo et al. Am J Hum Genet (1998) 62:768-775). After delivery, fetal nucleic acid is cleared very rapidly from the maternal plasma (Lo et al. Am J Hum Genet (1999) 64:218-224). Fetal nucleic acid is present in maternal plasma in a much higher fractional concentration than fetal nucleic acid in the cellular fraction of maternal blood (Lo et al. Am J Hum Genet (1998) 62:768-775). Thus, in another embodiment, a nucleic acid species is of fetal origin, while the other nucleic acid species is of maternal origin.

In some embodiments, the sample contains free maternal template DNA and free fetal template DNA. In certain embodiments, template DNA may include a mixture of maternal DNA and fetal DNA, and in one embodiment, prior to determining the sequence of alleles of a locus of interest from template DNA, maternal DNA is sequenced to identify a homozygous locus of interest, and the homozygous locus of interest is the locus of interest analyzed in the template DNA. In some embodiments, maternal DNA is sequenced to identify a heterozygous locus of interest, and the heterozygous locus of interest is the locus of interest analyzed in the template DNA. In certain embodiments, prior to determining the sequence, template DNA was isolated. In some embodiments, prior to determining the sequence of the locus of interest on fetal DNA, the sequence of the locus of interest on maternal template DNA was determined. In some embodiments, prior to determining the sequence of the locus of interest on fetal DNA, the sequence of the locus of interest on paternal template DNA is determined. In some embodiments, the locus of interest is a single nucleotide polymorphism. In other embodiments, the locus of interest is a mutation. In some embodiments, the sequence of multiple loci of interest is determined. In some of these embodiments, the multiple loci of interest are on multiple chromosomes.

A sample of the present invention may involve cell lysis, inactivation of cellular nucleases and separation of the desired nucleic acid from cellular debris. Common lysis procedures include mechanical disruption (e.g., grinding, hypotonic lysis), chemical treatment (e.g., detergent lysis, chaotropic agents, thiol reduction), and enzymatic digestion (e.g., proteinase K). In the present invention, the biological sample may be first lysed in the presence of a lysis buffer, chaotropic agent (e.g., salt) and proteinase or protease. Cell membrane disruption and inactivation of intracellular nucleases may be combined. For instance, a single solution may contain detergents to solubilize cell membranes and strong chaotropic salts to inactivate intracellular enzymes. After cell lysis and nuclease inactivation, cellular debris may easily be removed by filtration or precipitation.

In another embodiment, lysis may be blocked. In these embodiments, the sample may be mixed with an agent that inhibits cell lysis to inhibit the lysis of cells, if cells are present, where the agent is a membrane stabilizer, a cross-linker, or a cell lysis inhibitor. In some of these embodiments, the agent is a cell lysis inhibitor, and may be glutaraldehyde, derivatives of glutaraldehyde, formaldehyde, formalin, or derivatives of formaldehyde. See U.S. patent application 20040137470, which is hereby incorporated by reference.

The methods of the present invention may include detecting the sequence of a nucleic acid species. Any detection method known in the art may be used, including, but not limited to, gel electrophoresis, capillary electrophoresis, microchannel electrophoresis, polyacrylamide gel electrophoresis, fluorescence detection, fluorescence polarization, DNA sequencing, Sanger dideoxy sequencing, ELISA, mass spectrometry, time of flight mass spectrometry, quadrupole mass spectrometry, magnetic sector mass spectrometry, electric sector mass spectrometry, fluorometry, infrared spectrometry, ultraviolet spectrometry, palentiostatic amperometry, DNA hybridization, DNA microarray, GeneChip arrays, HuSNP arrays, BeadArrays, MassExtend, SNP-IT, TaqMan assay, Invader assay, MassCleave, southern blot, slot blot, or dot blot.

The methods of the present invention may be used to amplify, detect or quantify low copy number nucleic acid species relative to a high copy number nucleic acid species. In a preferred embodiment, the starting relative percentage of low copy number nucleic acid species to high copy number nucleic acid species in a sample is 0.5% to 49%. In a related embodiment, the starting relative percentage of low copy number nucleic acid species to high copy number nucleic acid species in a sample is 0.5-1.0% low copy number nucleic acid species, about 1.0-2.0% low copy number nucleic acid species, about 2.0-3.0% low copy number nucleic acid species, about 3.0-4.0% low copy number nucleic acid species, about 4.0-5.0% low copy number nucleic acid species, about 5.0-6.0% low copy number nucleic acid species, about 7.0-8.0% low copy number nucleic acid species, about 8.0-9.0% low copy number nucleic acid species, about 9.0-10% low copy number nucleic acid species, about 10-12% low copy number nucleic acid species, about 12-15% low copy number nucleic acid species, about 15-20% low copy number nucleic acid species, about 20-25% low copy number nucleic acid species, about 25-30% low copy number nucleic acid species, about 30-35% low copy number nucleic acid species, or about 35-45% low copy number nucleic acid species.

In a related embodiment, the final relative percentage of low copy number nucleic acid species to high copy number nucleic acid species is 5% to 80%. In a related embodiment, the final relative percentage of low copy number nucleic acid species to high copy number nucleic acid species in a sample is 5.0-6.0% low copy number nucleic acid species, about 6.0-7.0% low copy number nucleic acid species, about 7.0-8.0% low copy number nucleic acid species, about 8.0-9.0% low copy number nucleic acid species, about 9.0-10% low copy number nucleic acid species, about 10-15% low copy number nucleic acid species, about 15-20% low copy number nucleic acid species, about 20-25% low copy number nucleic acid species, about 25-30% low copy number nucleic acid species, about 30-35% low copy number nucleic acid species, about 35-40% low copy number nucleic acid species, about 40-45% low copy number nucleic acid species, about 45-50% low copy number nucleic acid species, about 50-55% low copy number nucleic acid species, about 55-60% low copy number nucleic acid species, about 60-65% low copy number nucleic acid species, about 65-70% low copy number nucleic acid species, about 70-75% low copy number nucleic acid species, about 75-80% low copy number nucleic acid species, or greater than 80% low copy number nucleic acid species.

In another example, the methods of the present invention may be used in conjunction with any technique suitable in the art for the extraction, isolation or purification of nucleic acids, including, but not limited to, cesium chloride gradients, gradients, sucrose gradients, glucose gradients, centrifugation protocols, boiling, Chemagen viral DNA/RNA 1 k kit, Chemagen blood kit, Qiagen purification systems, QIA DNA blood purification kit, HiSpeed Plasmid Maxi Kit, QIAfilter plasmid kit, Promega DNA purification systems, MangeSil Paramagnetic Particle based systems, Wizard SV technology, Wizard Genomic DNA purification kit, Amersham purification systems, GFX Genomic Blood DNA purification kit, Invitrogen Life Technologies Purification Systems, CONCERT purification system, Mo Bio Laboratories purification systems, UltraClean BloodSpin Kits, UlraClean Blood DNA Kit, and filtration through a Microcon 100 filter (Amicon, Mass.).

In another embodiment, it is not essential that the nucleic acid be extracted, purified, isolated or enriched; it only needs to be provided in a form that is capable of being amplified. Hybridization of the nucleic acid template with primer, prior to amplification, is not required. For example, amplification can be performed in a cell or sample lysate using standard protocols well known in the art. DNA that is on a solid support, in a fixed biological preparation, or otherwise in a composition that contains non-DNA substances and that can be amplified without first being extracted from the solid support or fixed preparation or non-DNA substances in the composition can be used directly, without further purification, as long as the DNA can anneal with appropriate primers, and be copied, especially amplified, and the copied or amplified products can be recovered and utilized as described herein.

In another embodiment, the described method may be used in combination with methods for rapid identification of unknown bioagents using a combination of nucleic acid amplification and determination of base composition of informative amplicons by molecular mass analysis as disclosed and claimed in published U.S. Patent applications 20030027135, 20030082539, 20030124556, 20030175696, 20030175695, 20030175697, and 20030190605 and U.S. patent application Ser. Nos. 10/326,047, 10/660,997, 10/660,122 and 10/660,996, all of which are incorporated herein by reference in entirety.

The present invention also further relates to kits for practicing the methods of the invention. Kits can comprise one or more containers, which contain one or more of the compositions and/or components described herein. A kit can comprise one or more of the components in any number of separate containers, packets, tubes, vials, microtiter plates and the like, or the components may be combined in various combinations in such containers. A kit can be utilized in conjunction with a method described herein, and sometimes includes instructions for performing one or more methods described herein and/or a description of one or more compositions or reagents described herein. Instructions and/or descriptions may be in printed form and may be included in a kit insert. A kit also may include a written description of an internet location that provides such instructions or descriptions.

Detection and Quantitative Analysis of Apoptotic Nucleic Acid

The methods provided herein are particularly useful for the amplification, detection and quantification of apoptotic nucleic acids in a sample. Programmed cell death or apoptosis is an essential mechanism in morphogenesis, development, differentiation, and homeostasis in all multicellular organisms. Typically, apoptosis is distinguished from necrosis by activation of specific pathways that result in characteristic morphological features including DNA fragmentation, chromatin condensation, cytoplasmic and nuclear breakdown, and the formation of apoptotic bodies.

Caspase-activated DNase (CAD), alternatively called DNA fragmentation factor (DFF or DFF40), has been shown to generate double-stranded DNA breaks in the internucleosomal linker regions of chromatin leading to nucleosomal ladders consisting of DNA oligomers of approximately 180 base pairs or multiples thereof. The majority of the ladder fragments (up to 70%) occur as nucleosomal monomers of 180 bp. All fragments carry 5′-phosphorylated ends and the majority of them are blunt-ended (Widlak et al, J Biol Chem. 2000 Mar. 17; 275(11):8226-32, which is hereby incorporated by reference).

Thus, there is an increasing need to characterize known mutations and epimutations of specific DNA fragments from specific cells or tissues or present as extracellular fragments in biological fluids in a target-specific manner in the presence of high background of wild type DNA (e.g. somatic mutations of DNA from cells responding to a xenobiotic of drug treatment; from inflamed, malignant or otherwise diseased tissues; from transplants or from differences of fetal and maternal DNA during pregnancy).

The present invention, therefore, provides methods for selectively amplifying, detecting and quantifying short, fragmented nucleic acid species present in a sample at low concentrations. The method is particularly useful for detecting oligonucleosomes. Oligonucleosomes are the repeating structural units of chromatin, each consisting of approximately 200 base pairs of DNA wound around a histone core that partially protects the DNA from nuclease digestion in vitro and in vivo. These units can be found as monomers or multimers and produce what is commonly referred to as an apoptotic DNA ladder. The units are formed by nuclease digestion of the flanking DNA not bound to histone resulting in the majority of oligonucleosomes being blunt ended and 5′-phorsphorylated. In biological systems in which only a small percentage of cells are apoptotic, or in which apoptosis is occurring asynchronously, oligonucleosomes are hard to detect and harder to isolate; however, they can serve as predictors for disease and other conditions (see US patent application 20040009518, which is hereby incorporated by reference). Thus, methods described herein can be utilized to detect nucleic acid (e.g., fetal nucleic acid) having a size of about 1000 base pairs or less, about 750 base pairs or less, about 500 base pairs or less and about 300 base pairs or less.

Diagnostic Applications

Circulating nucleic acids in the plasma and serum of patients are associated with certain diseases and conditions (See, Lo Y M D et al., N Eng J Med 1998;339:1734-8; Chen X Q, et al., Nat Med 1996;2:1033-5, Nawroz H et al., Nat Med 1996;2:1035-7; Lo Y M D et al., Lancet 1998;351:1329-30; Lo Y M D, et al., Clin Chem 2000;46:319-23). Further, the ability to detect and accurately quantify these disease-associated, low copy number nucleic acids circulating in the blood would prove very beneficial for disease diagnosis and prognosis (Wang et al. Clin Chem. 2004 January; 50(1):211-3).

The characteristics and biological origin of circulating nucleic acids are not completely understood. However, it is likely that cell death, including apoptosis, is one major factor (Fournie e al., Gerontology 1993;39:215-21; Fournie et al., Cancer Lett 1995;91:221-7). Without being bound by theory, as cells undergoing apoptosis dispose nucleic acids into apoptotic bodies, it is possible that at least part of the circulating nucleic acids in the plasma or serum of human subjects is short, fragmented DNA that takes the form particle-associated nucleosomes. The present invention provides methods for amplifying, detecting and quantifying the short, fragmented circulating nucleic acid species present in the plasma or serum of subjects at low concentrations relative to other high copy number species also present in the plasma or serum.

The present invention provides methods of evaluating a disease condition in a patient suspected of suffering or known to suffer from the disease condition. In one embodiment of the present invention, the invention includes obtaining a biological sample from the patient suspected of suffering or known to suffer from a disease condition, preferentially amplifying, detecting or quantifying a low copy number nucleic acid species using the methods provided herein, and evaluating the disease condition by determining the amount or concentration or characteristic of the nucleic acid species and comparing the amount or concentration or characteristic of the nucleic acid species to a control (e.g., background genomic DNA from biological sample, high copy number species, high frequency allele, etc.).

The phrase “evaluating a disease condition” refers to assessing the disease condition of a patient. For example, evaluating the condition of a patient can include detecting the presence or absence of the disease in the patient. Once the presence of disease in the patient is detected, evaluating the disease condition of the patient may include determining the severity of disease in the patient. It may further include using that determination to make a disease prognosis, e.g. a prognosis or treatment plan. Evaluating the condition of a patient may also include determining if a patient has a disease or has suffered from a disease condition in the past. Evaluating the disease condition in that instant might also include determining the probability of reoccurrence of the disease condition or monitoring the reoccurrence in a patient. Evaluating the disease condition might also include monitoring a patient for signs of disease. Evaluating a disease condition therefore includes detecting, diagnosing, or monitoring a disease condition in a patient as well as determining a patient prognosis or treatment plan. The method of evaluating a disease condition aids in risk stratification.

Cancer

The methods provided herein may be used to amplify, detect and quantify oncogenic nucleic acid, which may be further used for the diagnosis or prognosis of a cancer-related disorder. In plasma from cancer patients, nucleic acids, including DNA and RNA, are known to be present (Lo K W, et al. Clin Chem (1999) 45,1292-1294). These molecules are likely packaged in apoptotic bodies and, hence, rendered more stable compared to ‘free RNA’ (Anker P and Stroun M, Clin Chem (2002) 48, 1210-1211; Ng EK, et al. Proc Natl Acad Sci USA (2003) 100, 4748-4753).

In the late 1980s and 1990s several groups demonstrated that plasma DNA derived from cancer patients displayed tumor-specific characteristics, including decreased strand stability, Ras and p53 mutations, mircrosatellite alterations, abnormal promoter hypermethylation of selected genes, mitochondrial DNA mutations and tumor-related viral DNA (Stroun M, et al. Oncology (1989) 46,318-322; Chen X Q, et al. Nat Med (1996) 2,1033-1035; Anker P, et al. Cancer Metastasis Rev (1999) 18,65-73; Chan KC and Lo YM, Histol Histopathol (2002) 17,937-943). Tumor-specific DNA for a wide range of malignancies has been found: haematological, colorectal, pancreatic, skin, head-and-neck, lung, breast, kidney, ovarian, nasopharyngeal, liver, bladder, gastric, prostate and cervix. In aggregate, the above data show that tumor-derived DNA in plasma is ubiquitous in affected patients, and likely the result of a common biological process such as apoptosis. Investigations into the size of these plasma DNA fragments from cancer patients has revealed that the majority show lengths in multiples of nucleosomal DNA, a characteristic of apoptotic DNA fragmentation (Jahr S, et al. Cancer Res (2001) 61,1659-1665).

If a cancer shows specific viral DNA sequences or tumor suppressor and/or oncogene mutant sequences, the methods of the present. However, for most cancers (and most Mendelian disorders), clinical application awaits optimization of methods to isolate, quantify and characterize the tumor-specific DNA compared to the patient's normal DNA, which is also present in plasma. Therefore, understanding the molecular structure and dynamics of DNA in plasma of normal individuals is necessary to achieve further advancement in this field.

Thus, the present invention relates to detection of specific extracellular nucleic acid in plasma or serum fractions of human or animal blood associated with neoplastic, pre-malignant or proliferative disease. Specifically, the invention relates to detection of nucleic acid derived from mutant oncogenes or other tumor-associated DNA, and to those methods of detecting and monitoring extracellular mutant oncogenes or tumor-associated DNA found in the plasma or serum fraction of blood by using DNA extraction with enrichment for mutant DNA as provided herein. In particular, the invention relates to the detection, identification, or monitoring of the existence, progression or clinical status of benign, premalignant, or malignant neoplasms in humans or other animals that contain a mutation that is associated with the neoplasm through the size selective enrichment methods provided herein, and subsequent detection of the mutated nucleic acid of the neoplasm in the enriched DNA.

The present invention features methods for identifying DNA originating from a tumor in a biological sample. These methods may be used to differentiate or detect tumor-derived DNA in the form of apoptotic bodies or nucleosomes in a biological sample. In preferred embodiments, the non-cancerous DNA and tumor-derived DNA are differentiated by observing nucleic acid size differences, wherein low base pair DNA is associated with cancer.

Prenatal Diagnostics

Since 1997, it is known that free fetal DNA can be detected in the blood circulation of pregnant women. In absence of pregnancy-associated complications, the total concentration of circulating DNA is in the range of 10-100 ng or 1,000 to 10,000 genome equivalents/ml plasma (Bischoff et al., Hum Reprod Update. 2005 January-February; 11 (1):59-67 and references cited therein) while the concentrations of the fetal DNA fraction increases from ca. 20 copies/ml in the first trimester to >250 copies/ml in the third trimester. After electron microscopic investigation and ultrafiltration enrichment experiments, the authors conclude that apoptotic bodies carrying fragmented nucleosomal DNA of placental origin are the source of fetal DNA in maternal plasma.

It has been demonstrated that the circulating DNA molecules are significantly larger in size in pregnant women than in non-pregnant women with median percentages of total plasma DNA of >201 bp at 57% and 14% for pregnant and non-pregnant women, respectively while the median percentages of fetal-derived DNA with sizes >193 bp and >313 bp were only 20% and 0%, respectively (Chan et al, Clin Chem. 2004 January; 50(1):88-92).

These findings have been independently confirmed (Li et al, Clin Chem. 2004 June; 50(6):1002-11); Patent application US200516424, which is hereby incorporated by reference) who showed as a proof of concept, that a >5 fold relative enrichment of fetal DNA from ca. 5% to >28% of total circulating plasma DNA is possible be means of size exclusion chromatography via preparative agarose gel electrophoresis and elution of the <300 bp size fraction. Unfortunately, the method is not very practical for reliable routine use because it is difficult to automate and due to possible loss of DNA material and the low concentration of the DNA recovered from the relevant Agarose gel section.

Thus, the present invention features methods for differentiating DNA species originating from different individuals in a biological sample. These methods may be used to differentiate, detect or quantify fetal DNA in a maternal sample.

There are a variety of non-invasive and invasive techniques available for prenatal diagnosis including ultrasonography, amniocentesis, chorionic villi sampling (CVS), fetal blood cells in maternal blood, maternal serum alpha-fetoprotein, maternal serum beta-HCG, and maternal serum estriol. However, the techniques that are non-invasive are less specific, and the techniques with high specificity and high sensitivity are highly invasive. Furthermore, most techniques can be applied only during specific time periods during pregnancy for greatest utility

The first marker that was developed for fetal DNA detection in maternal plasma was the Y chromosome, which is present in male fetuses (Lo et al. Am J Hum Genet (1998) 62:768-775). The robustness of Y chromosomal markers has been reproduced by many workers in the field (Costa J M, et al. Prenat Diagn 21:1070-1074). This approach constitutes a highly accurate method for the determination of fetal gender, which is useful for the prenatal investigation of sex-linked diseases (Costa J M, Ernault P (2002) Clin Chem 48:679-680).

Maternal plasma DNA analysis is also useful for the noninvasive prenatal determination of fetal RhD blood group status in RhD-negative pregnant women (Lo et al. (1998) N Engl J Med 339:1734-1738). This approach has been shown by many groups to be accurate, and has been introduced as a routine service by the British National Blood Service since 2001 (Finning K M, et al. (2002) Transfusion 42:1079-1085).

More recently, maternal plasma DNA analysis has been shown to be useful for the noninvasive prenatal exclusion of fetal β-thalassemia major (Chiu R W K, et al. (2002) Lancet 360:998-1000). A similar approach has also been used for prenatal detection of the HbE gene (Fucharoen G, et al. (2003) Prenat Diagn 23:393-396).

Other genetic applications of fetal DNA in maternal plasma include the detection of achondroplasia (Saito H, et al. (2000) Lancet 356:1170), myotonic dystrophy (Amicucci P, et al. (2000) Clin Chem 46:301-302), cystic fibrosis (Gonzalez-Gonzalez M C, et al. (2002) Prenat Diagn 22:946-948), Huntington disease (Gonzalez-Gonzalez M C, et al. (2003) Prenat Diagn 23:232-234), and congenital adrenal hyperplasia (Rijnders R J, et al. (2001) Obstet Gynecol 98:374-378). It is expected that the spectrum of such applications will increase over the next few years.

In another aspect of the present invention, the patient is pregnant and the method of evaluating a disease or physiologic condition in the patient or her fetus aids in the detection, monitoring, prognosis or treatment of the patient or her fetus. More specifically, the present invention features methods of detecting abnormalities in a fetus by detecting fetal DNA in a biological sample obtained from a mother. The methods according to the present invention provide for detecting fetal DNA in a maternal sample by differentiating the fetal DNA from the maternal DNA based on DNA characteristics (e.g., size, weight, 5′ phosphorylated, blunt end). See Chan et al. Clin Chem. 2004 January; 50(1):88-92; and Li et al. Clin Chem. 2004 June; 50(6):1002-11. Employing such methods, fetal DNA that is predictive of a genetic anomaly or genetic-based disease may be identified thereby providing methods for prenatal diagnosis. These methods are applicable to any and all pregnancy-associated conditions for which nucleic acid changes, mutations or other characteristics (e.g., methylation state) are associated with a disease state. The methods and kits of the present invention allow for the analysis of fetal genetic traits including those involved in chromosomal aberrations (e.g. aneuploidies or chromosomal aberrations associated with Down's syndrome) or hereditary Mendelian genetic disorders and, respectively, genetic markers associated therewith (e.g. single gene disorders such as cystic fibrosis or the hemoglobinopathies). Additional diseases that may be diagnosed include, for example, preeclampsia, preterm labor, hyperemesis gravidarum, ectopic pregnancy, fetal chromosomal aneuploidy (such as trisomy 18, 21, or 13), and intrauterine growth retardation.

In another embodiment, alleles of multiple loci of interest are sequenced and their relative amounts quantified and compared. In one embodiment, the sequence of alleles of one to tens to hundreds to thousands of loci of interest on a single chromosome on template DNA is determined.

In another embodiment, the sequence of alleles of one to tens to hundreds to thousands of loci of interest on multiple chromosomes is detected and quantified.

There is no limitation as to the chromosomes that can be analyzed. The ratio for the alleles at a heterozygous locus of interest on any chromosome can be compared to the ratio for the alleles at a heterozygous locus of interest on any other chromosome. In another embodiment, the ratio of alleles at a heterozygous locus of interest on a chromosome is compared to the ratio of alleles at a heterozygous locus of interest on two, three, four or more than four chromosomes. In another embodiment, the ratio of alleles at multiple loci of interest on a chromosome is compared to the ratio of alleles at multiple loci of interest on two, three, four, or more than four chromosomes. In some of these embodiments, the chromosomes that are compared are human chromosomes such as chromosome 1, 2, 3, 4, 5, 6, 7, 8, 9, 10, 11, 12, 13, 14, 15, 16, 17, 18, 19, 20, 21, 22, X, or Y. In a related embodiment, the ratio for the alleles at heterozygous loci of interest of chromosomes 13, 18, and 21 are compared. In another embodiment, the sequence of one to tens to hundreds to thousands of loci of interest on the template DNA obtained from a sample of a pregnant female is determined. In one embodiment, the loci of interest are on one chromosome. In another embodiment, the loci of interest are on multiple chromosomes.

The term “chromosomal abnormality” refers to a deviation between the structure of the subject chromosome and a normal homologous chromosome. The term “normal” refers to the predominate karyotype or banding pattern found in healthy individuals of a particular species. A chromosomal abnormality can be numerical or structural, and includes but is not limited to aneuploidy, polyploidy, inversion, a trisomy, a monosomy, duplication, deletion, deletion of a part of a chromosome, addition, addition of a part of chromosome, insertion, a fragment of a chromosome, a region of a chromosome, chromosomal rearrangement, and translocation. A chromosomal abnormality can be correlated with presence of a pathological condition or with a predisposition to develop a pathological condition.

Other Diseases

Many diseases, disorders and conditions (e.g., tissue or organ rejection) produce apoptotic or nucleosomal DNA that may be detected by the methods provided herein. Diseases and disorders believed to produce apoptotic DNA include diabetes, heart disease, stroke, trauma and rheumatoid arthritis. Lupus erythematosus (SLE) (Rumore and Steinman J Clin Invest. 1990 July; 86(1):69-74). Rumore et al. noted that DNA purified from SLE plasma formed discrete bands, corresponding to sizes of about 150-200, 400, 600, and 800 bp, closely resembling the characteristic 200 bp “ladder” found with oligonucleosomal DNA.

The present invention also provides a method of evaluating the disease condition of a patient suspected of having suffered from a trauma or known to have suffered from a trauma. The method includes obtaining a sample of plasma or serum from the patient suspected of having suffered from a trauma or known to have had suffered from a trauma, and detecting the quantity or concentration of mitochondrial nucleic acid in the sample.

### EXAMPLES

The following examples are illustrative and not limiting. Biased Allele Specific (BAS) amplification methods described hereafter can be utilized to detect and measure nucleic acids of low copy number and can be adapted to determine, for example, the genotype of an individual. Such a genotype is a single nucleotide polymorphism in this example. An example of the steps one would take to determine such a genotype, using, for example, a mass spectrometry-based system is as follows. Some of the steps, such as steps in Examples 1 and 2, need be performed only once to generate data which is subsequently used (or provided, or incorporated into a test kit or algorithm) in carrying out the SNP (or other) assay.

### Example 1

### Primer Ratio Optimization

For identification of a particular SNP (a SNP assay), an optimal ratio of high-copy-number primer to low-copy-number primer is determined. An example of an experimental set-up through which such a determination can be made is shown in Tables 1 and 2. Specific amplification conditions are shown in Tables 3-5 and related text.

TABLE 1

| | | X Oligo Ratio | | | | | | |
|---|---|---|---|---|---|---|---|---|
| | | NA | 100% | 75% | 50% | 20% | 10% | 5% |
| Y DNA Ratio | Well | 01 | 02 | 03 | 04 | 05 | 06 | 07 |
| 0.00% | A | 1_XY1 | 1_X1(0) | 1_X + Y(0.5) | 1_X + Y(1) | 1_X + Y(25) | 1_X + Y(5) | 1_X + Y(10) |
| 1.03% | B | 2_XY1 | 2_X1(0) | 2_X + Y(0.5) | 2_X + Y(1) | 2_X + Y(25) | 2_X + Y(5) | 2_X + Y(10) |
| 2.02% | C | 3_XY1 | 3_X1(0) | 3_X + Y(0.5) | 3_X + Y(1) | 3_X + Y(25) | 3_X + Y(5) | 3_X + Y(10) |
| 4.95% | D | 4_XY1 | 4_X1(0) | 4_X + Y(0.5) | 4_X + Y(1) | 4_X + Y(25) | 4_X + Y(5) | 4_X + Y(10) |
| 10.00% | E | 5_XY1 | 5_X1(0) | 5_X + Y(0.5) | 5_X + Y(1) | 5_X + Y(25) | 5_X + Y(5) | 5_X + Y(10) |
| 20.59% | F | 6_XY1 | 6_X1(0) | 6_X + Y(0.5) | 6_X + Y(1) | 6_X + Y(25) | 6_X + Y(5) | 6_X + Y(10) |
| 40.00% | G | 7_XY1 | 7_X1(0) | 7_X + Y(0.5) | 7_X + Y(1) | 7_X + Y(25) | 7_X + Y(5) | 7_X + Y(10) |
| 50.00% | H | 8_XY1 | 8_X1(0) | 8_X + Y(0.5) | 8_X + Y(1) | 8_X + Y(25) | 8_X + Y(5) | 8_X + Y(10) |

| | | X Oligo Ratio | | | | |
|---|---|---|---|---|---|---|
| | | 2% | 1% | 0.50% | 0% | |
| Y DNA Ratio | Well | 08 | 09 | 10 | 11 | 12 |
| 0.00% | A | 1_X + Y(25) | 1_X + Y(50) | 1_X + Y(100) | 1_Y1(0) | NTC |
| 1.03% | B | 2_X + Y(25) | 2_X + Y(50) | 2_X + Y(100) | 2_Y1(0) | NTC |
| 2.02% | C | 3_X + Y(25) | 3_X + Y(50) | 3_X + Y(100) | 3_Y1(0) | NTC |
| 4.95% | D | 4_X + Y(25) | 4_X + Y(50) | 4_X + Y(100) | 4_Y1(0) | NTC |
| 10.00% | E | 5_X + Y(25) | 5_X + Y(50) | 5_X + Y(100) | 5_Y1(0) | NTC |
| 20.59% | F | 6_X + Y(25) | 6_X + Y(50) | 6_X + Y(100) | 6_Y1(0) | NTC |
| 40.00% | G | 7_X + Y(25) | 7_X + Y(50) | 7_X + Y(100) | 7_Y1(0) | NTC |
| 50.00% | H | 8_X + Y(25) | 8_X + Y(50) | 8_X + Y(100) | 8_Y1(0) | NTC |

TABLE 2
Oligo Dilution Preparation

| Oligo Dilutions To be Prepared at 1 uM for S Primers Only | | | | | | | | At 1.0 uM for X |
|---|---|---|---|---|---|---|---|---|
| | | | | | | | Water | Final Total |
| | X Dilution | X | Y | X (uL) | Y (uL) | Total | (uL) | (uL) |
| X1 | 1 | 1 | 0 | 12.5 | 0 | 12.5 | 987.5 | 1000.0 |
| X + Y(0.5) | 1 | 1 | 0.5 | 2.0 | 1.0 | 3.0 | 197.0 | 100.0 |
| X + Y(1) | 1 | 1 | 1 | 12.5 | 12.5 | 25 | 975.0 | 1000.0 |
| X + Y(2.5) | 1 | 1 | 2.5 | 1 | 2.5 | 3.5 | 96.5 | 100.0 |
| X + Y(5) | 1 | 1 | 5 | 1 | 5 | 6.0 | 94.0 | 100.0 |
| X + Y(10) | 1 | 1 | 10 | 1 | 10 | 11 | 89.0 | 100.0 |
| X + Y(25) | 1 | 1 | 25 | 1 | 25 | 26 | 74.0 | 100.0 |
| X + Y(50) | 1 | 1 | 50 | 1 | 50 | 51 | 49.0 | 100.0 |
| X + Y(100) | 0.05 | 1 | 100 | 4 | 20 | 24 | 0 | 24.0 |
| Y1 | 1 | 0 | 1 | 0 | 12.5 | 12.5 | 987.5 | 1000.0 |

Notes:
X Dilution = 1 = at 100 ng/uL
X Dilution = 0.05 = at 5 ng/uL

Eight (8) ng of genomic DNA with different mixing ratio of male and female samples are subject to PCR amplification with varying ratio of allele specific oligos as outline in the table.

TABLE 3
PCR

| | | |
|---|---|---|
| Reagents | Conc. | 1 Well (ul) |

| H₂O | | | 1.35 |
|---|---|---|---|
| PCR buffer | 10× | | 0.625 |
| MgCl₂ | 25 | mM | 0.325 |
| dNTPmix | 25 | mM | 0.2 |
| F/R primer | 1.25 | | 0.4 |
| Enzyme Taq | 5 | u | 0.1 |
| Genomic DNA | 4 | ng | 2 |
| Total Volume | | ul | 5 |

PCR cycling is for 45 cycles, where each cycle is 94° C. for 15 minutes, 94° C. for 20 seconds, 56° C. for 30 seconds, 72° C. for 1 minute, 72° C. for 3 minutes, and then the products are maintained at 4° C. thereafter.

TABLE 4

| SAP Step | microliter |
|---|---|
| H₂O | 1.33 |
| 10× SAP Buffer | 0.17 |
| SAP Enzyme | 0.5 |
| Total | 2 |

Add 2 microliters of the SAP mix to each 5 microliter PCR reaction. Incubate the SAP-treated PCR reaction, and then maintain at the following temperatures: 37° C. for 20 minutes, •85° C. for 5 minutes and 4° C. thereafter. TABLE 5

TABLE 5
MassExtension

| | | 1 Well |
|---|---|---|
| Reagents | Conc. | (microliter) |
| H₂O | | 0.5 |
| EXT buffer | 10× | 0.2 |
| MgCl₂ | 100 mM | 0.02 |
| Term. mix | iPLEX | 0.2 |
| E Oligo mix | 2 Tiers | 1 |
| Enzyme | TP | 0.1 |
| Total Volume | microliter | 2 |

For iPLEX extension, 200 short cycles are carried out, where each cycle includes 94° C. for 30 seconds, 94° C. for 5 seconds, 52° C. for 5 seconds, 80° C. for 5 seconds and 72° C. for 3 minutes, and then the products are maintained at 4° C. thereafter. Further processing and analysis includes deslating with 6 mg of resin, dispensing to SpectroChip Bioarrays and MALDI-TOF MS analysis.

In this example, nucleic acids samples from males and females, and of known concentration of nucleic acid, are mixed in a proportion to provide a particular Y chromosome allele ratio (Y DNA Ratio) indicated on the Y axis. In this example, a particular SNP known to be present only on the Y chromosome (or at least not on the X chromosome) is chosen for use, and another specific SNP known to be present only on the X chromosome (or at least not on the Y chromosome) is chosen for use. For example the 0.00% ratio has no male nucleic acid, and hence no Y allele. The 50% Y DNA Ratio is mixed so it has more male sample than female sample in an amount to provide 50% Y allele, which takes into account the XX chromosomal makeup of a female and the XY chromosomal makeup of a male. The X axis of Table 1 shows volumetric proportions of X and Y-specific oligos solutions mixed to provide the X oligo ratios indicated. The nucleic acid samples from each of the 96 reaction conditions specified in Table 1 (additional details of the amplification reactions which generate results are provided herein) then are analyzed, in this case, by mass spectrometry. See also Table 2.

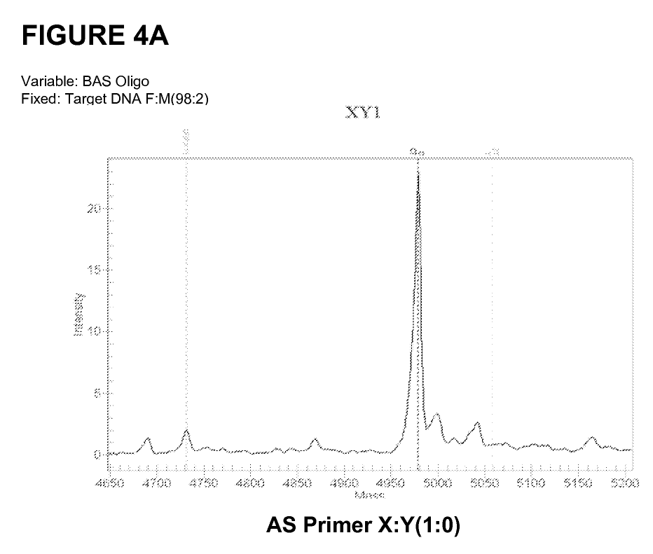

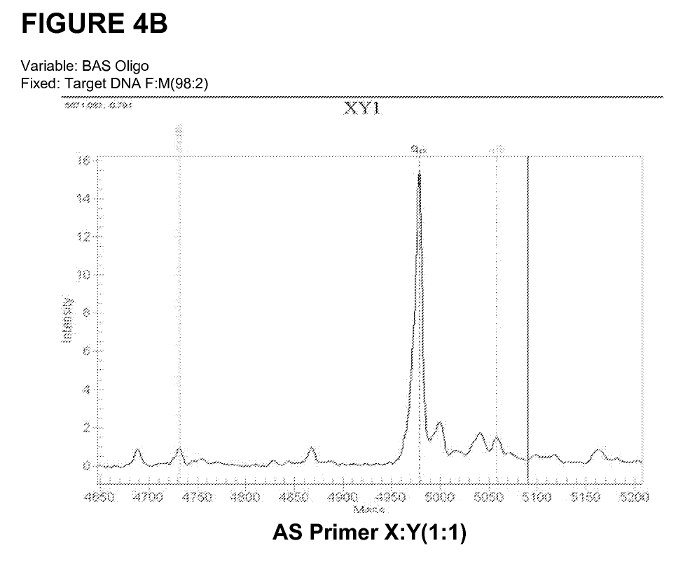

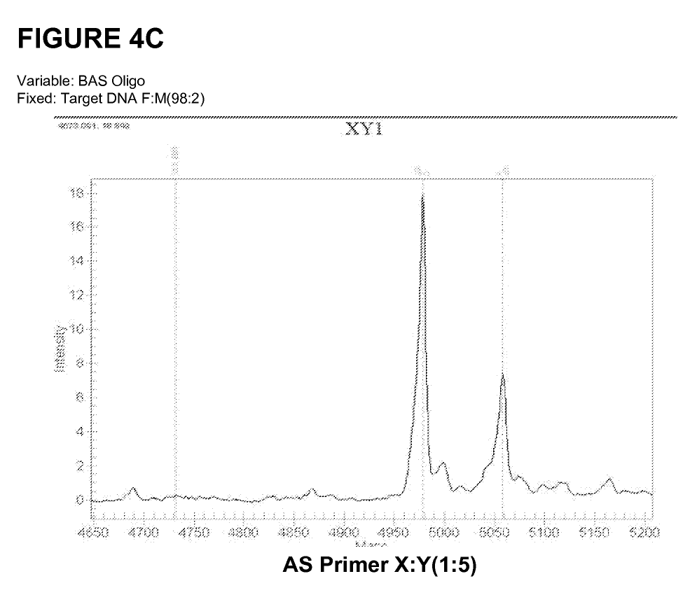

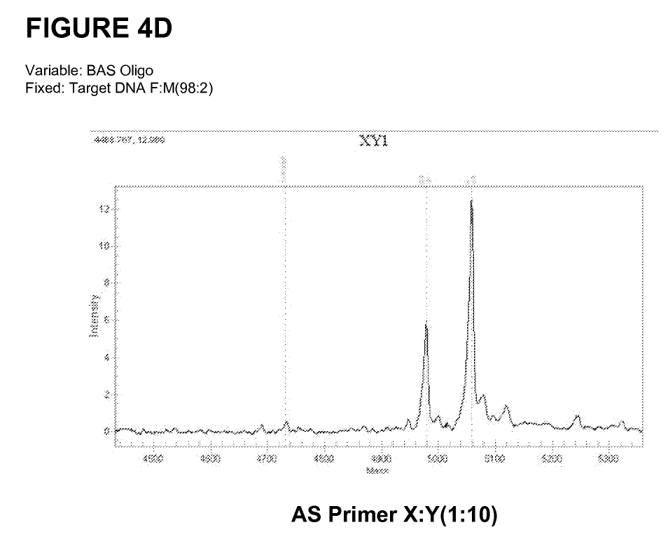

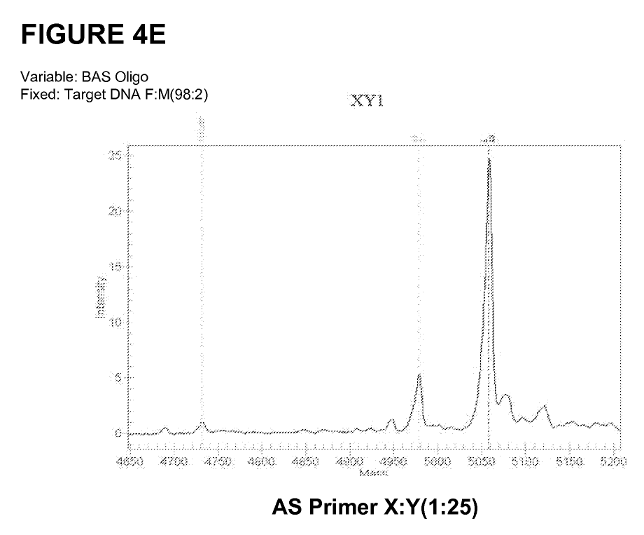

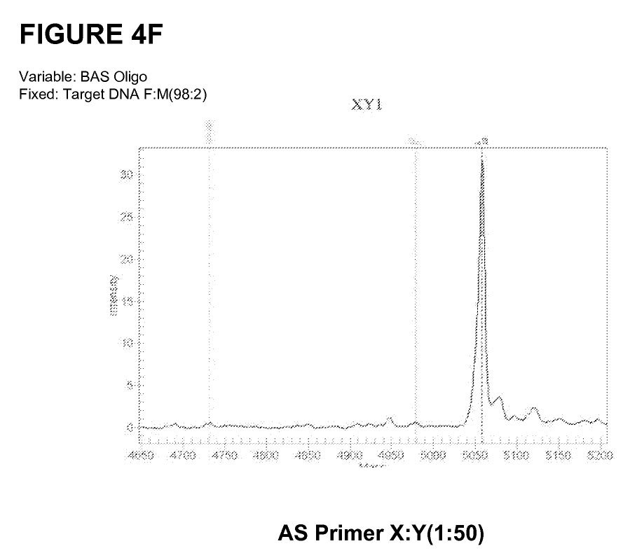

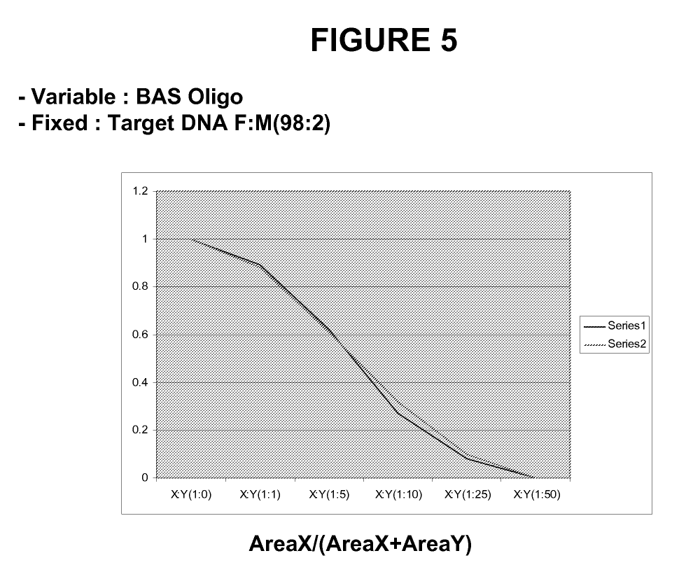

As shown in FIGS. 4A-F, various mass spectrograms are obtained. The two peaks are each specific, one for the X chromosome SNP and the other for the Y chromosome SNP. For example, the spectrograms of FIGS. 4A-F corresponds to Row C (as indicated the (Target DNA F:M 98:2)) means that the male or Y allele is present at 2%. However, FIG. 4A illustrates an X:Y ratio of primers of 1:10, which corresponds approximately to the conditions shown in column 6. As is illustrated, as the proportion of low copy number primer (in this case for the Y chromosome SNP) is increased, the right hand peak increases in size. In FIG. 4A, with 0 Y-specific primer present, no male-specific (right hand side) peak is detectable. In FIG. 4F, with a 50-fold excess of Y-specific primer the male peak is very large. For many, if not most, applications (i.e., detection methods), an optimal primer ratio is that which yields an about 1:1 peak size ratio. As illustrated in FIGS. 4C-D a 1:5 primer ratio is too small and a 1:10 primer ratio is too much, while about a 1:7 ratio would be expected to result in 1:1 area peaks (not shown). These features also are illustrated in FIG. 5. For this particular assay, in which a SNP is being detected and quantified, and using these primers, any other sample can be analyzed in which the nucleic acid comprising the low copy number species (such as fetal nucleic acid among maternal nucleic acid in plasma or serum) is about 1% to about 15% of the nucleic acid, by using the primer ratio of high copy number to low copy number of 1:10. Similar considerations and steps can be utilized for adapting the assay to other detection schemes, such as real time PCR and fluorescence-based detection systems, for example. This 1:10 ratio of primers which yields an optimal 1:1 peak ratio may vary from assay to assay, and may vary based on the percentage of nucleic acid that is low copy number versus high copy number. Such a variance can be from 1:2 to about 1:20, for example.

### Example 2

### Amplification of Low Copy Number Nucleic Acids

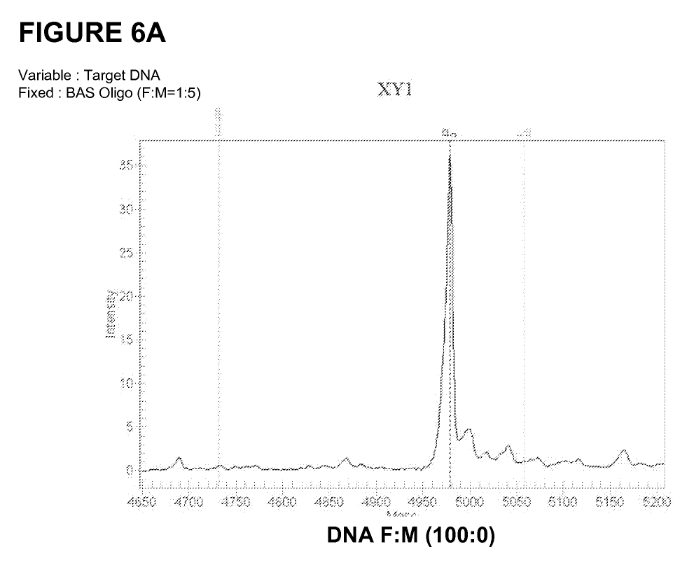

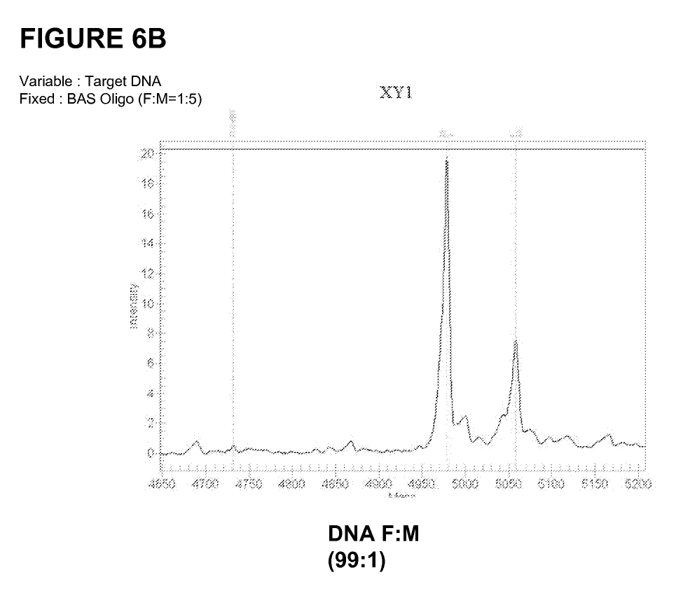

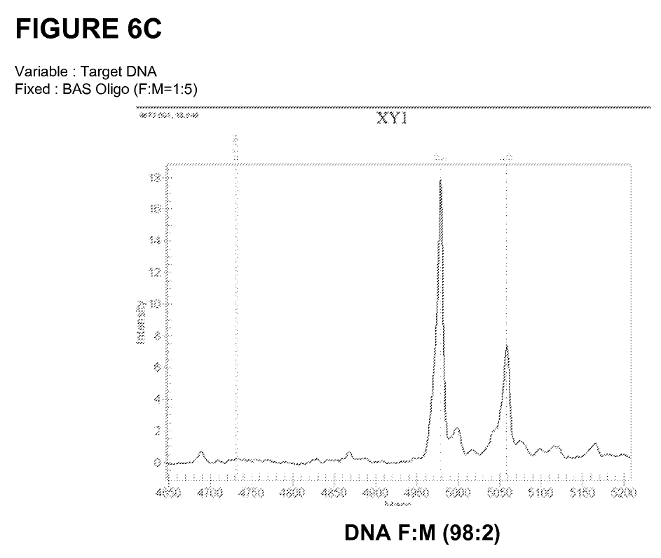

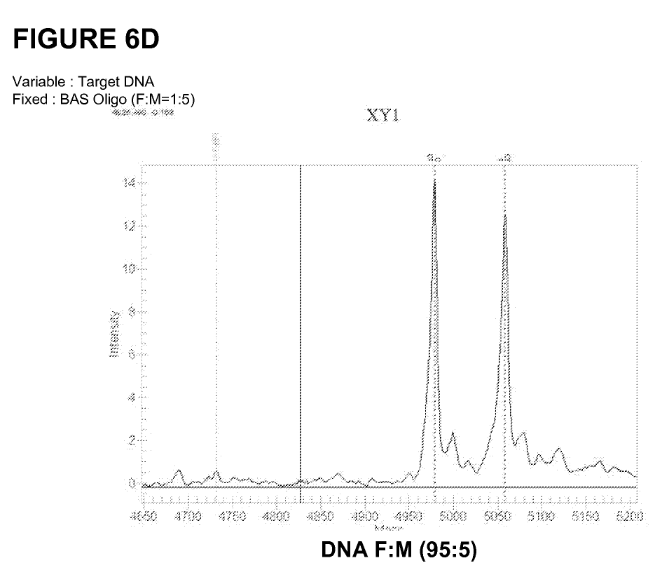

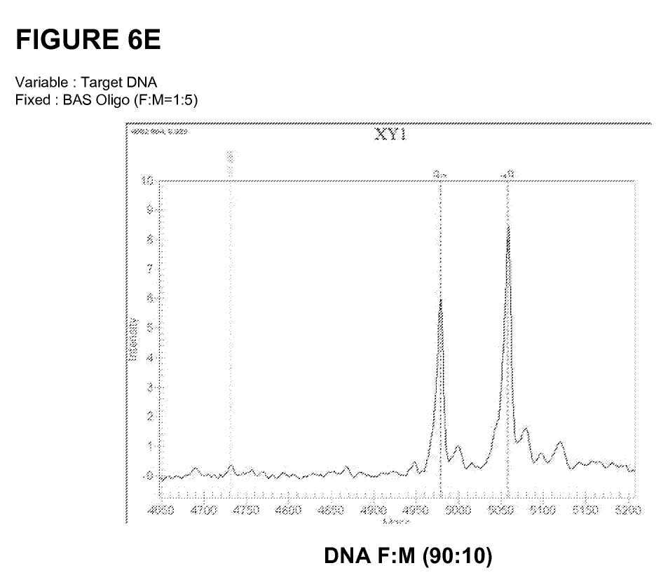

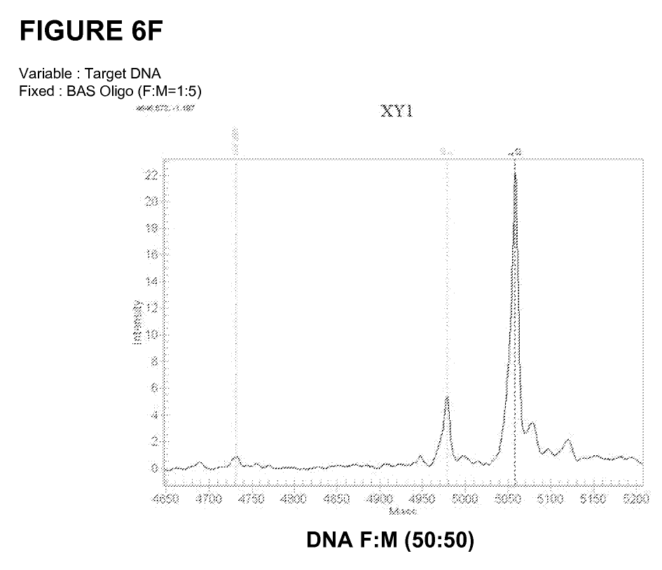

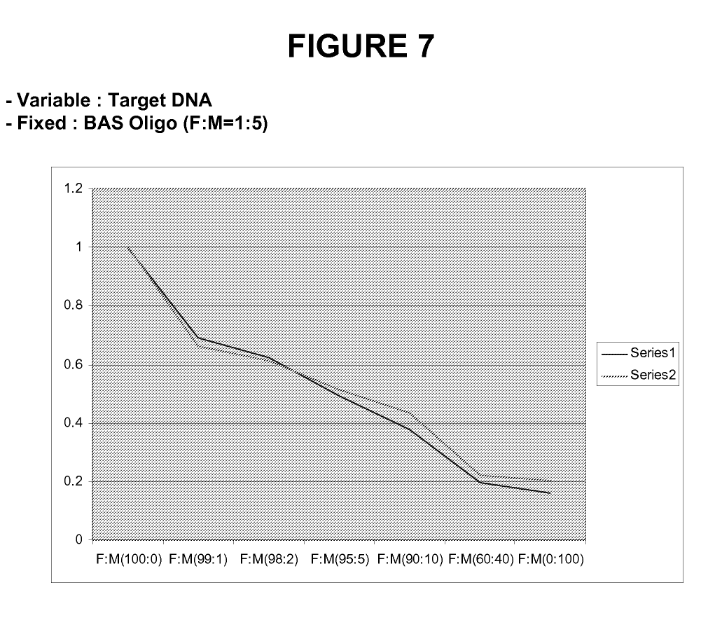

Once the optimal primer ratio is known, this ratio of primers is used to amplify low copy and high copy number nucleic acid of varying proportions, as illustrated in FIGS. 6A-6F. The proportions of high copy number (female) to low copy number (male) nucleic acid can vary from 100:0 in FIG. 4A, to 50:50 in FIG. 4F, for example. The area of one peak over the sum of both peaks can be plotted as shown in FIG. 7.

### Example 3

### Determining Genotype Information

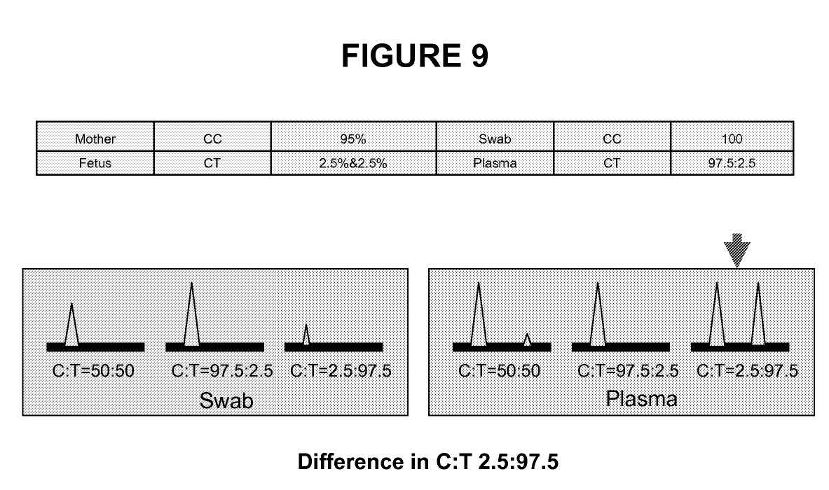

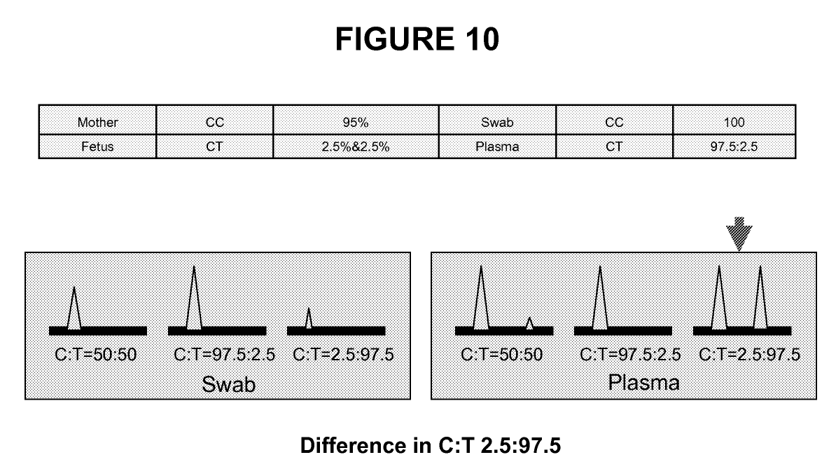

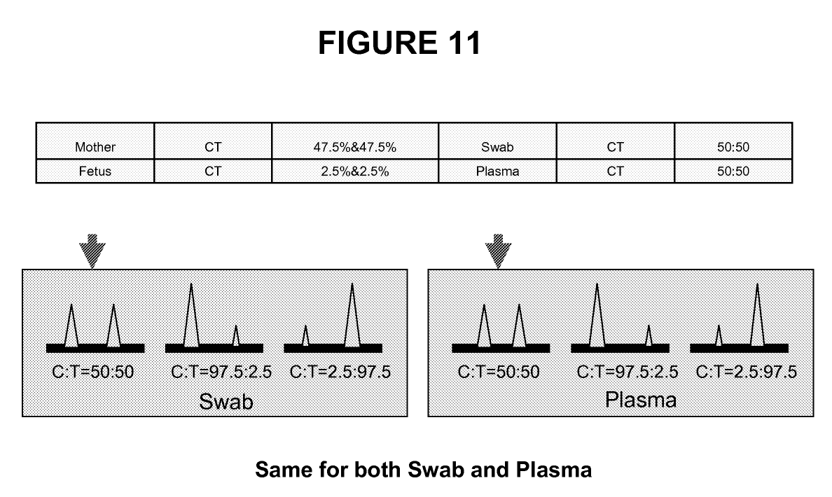

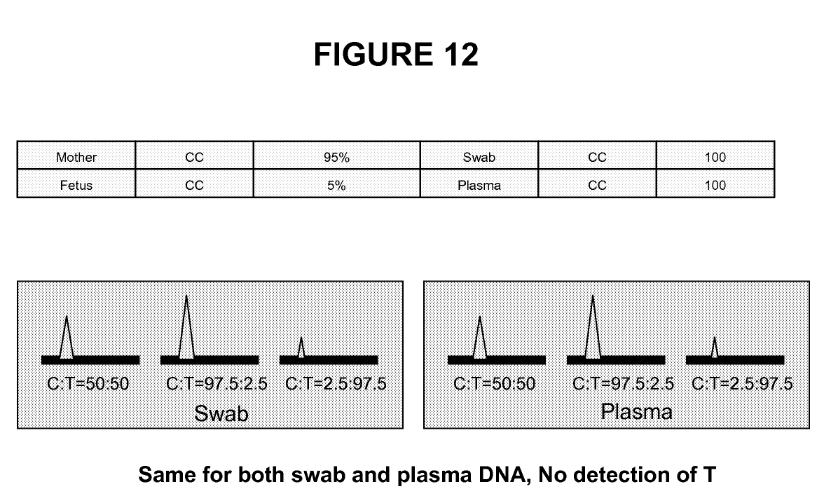

A genotype of an individual can be determined, and in particular, RhD compatibility or incompatibility between a fetus and mother can be determined in certain applications of the technology. In such embodiments there are four possible genotypes combinations between the mother and the fetus, which are illustrated in FIGS. 9-12. By obtaining a mother-only sample and running three separate reactions on that maternal sample, and comparing them to the three separate reactions obtained for a maternal plus fetal sample, one can determine the genotype of the mother and fetus. The three separate reactions are a high-copy number C allele primer, a high copy number T allele primer and an equal concentration C allele and T allele primer reaction. These same three reactions are run for both sample types.

### Example 4

### Quantitative Assessment of Genotype Information

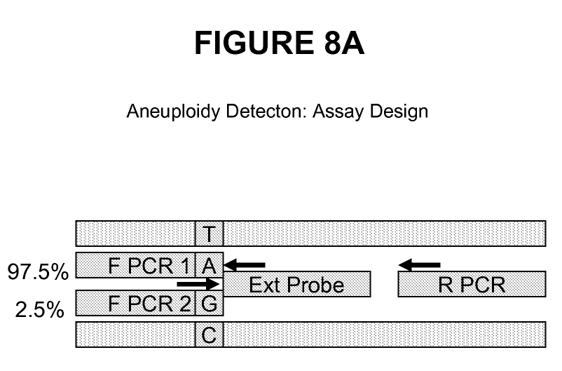

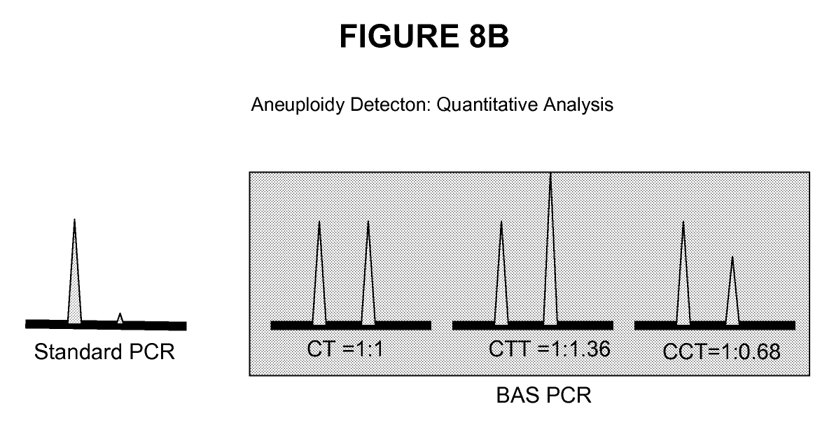

For certain applications of the technology, such as chromosomal aneuploidy determination, a quantitative determination is required. Having obtained a plot, such as depicted in FIG. 7, when one obtains a spectrogram for a sample containing an unknown percentage of low copy number to high copy number nucleic acid, the spectrogram may be analyzed by comparing the areas of the peaks generated in the sample. Specifically, one can obtain a ratio (between 0 and 1) as shown on the X axis, and then determine the corresponding high:low copy number ratio on the Y axis. For example, if the ratio of the areas is 0.6, then, as indicated on FIG. 7, the F:M ratio is 98:2. To determine an aneuploidy result, one preferably uses at least two SNP assays that each provide a different low copy number:high copy number ratio. An example of this approach is as follows. A fetal genotype against a maternal background (often 1%-5% fetal versus 99%-95% maternal; FIGS. 8A-8B) is to be determined. The maternal genotype is homozygous (wild type or mutant/dominant or recessive), and the fetal genotype is heterozygous. Assume the mother is CC at one allele and the fetus is CCT. If both the mother and the fetus are homozygous, the assay will not be informative. This possibility can be overcome by using multiple SNP assays, such as greater than 5, or more preferably greater than about 10, so that the probability of all the assays being non-informative is very low. Therefore, in this example, another SNP genotype is determined and the mother is CC and the fetus is CTT. One performs the biased allele amplification reaction for each SNP using the ratios calculated as set forth above. By comparing the ratios of the spectrogram peaks obtained one can both detect the trisomy and determine if the trisomy is CCT or CTT.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, yet these modifications and improvements are within the scope and spirit of the invention.

The invention illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the invention claimed. The term “a” or “an” can refer to one of or a plurality of the elements it modifies (e.g., “a device” can mean one or more devices) unless it is contextually clear either one of the elements or more than one of the elements is described. The term “about” as used herein refers to a value sometimes within 10% of the underlying parameter (i.e., plus or minus 10%), a value sometimes within 5% of the underlying parameter (i.e., plus or minus 5%), a value sometimes within 2.5% of the underlying parameter (i.e., plus or minus 2.5%), or a value sometimes within 1% of the underlying parameter (i.e., plus or minus 1%), and sometimes refers to the parameter with no variation. For example, a weight of “about 100 grams” can include weights between 90 grams and 110 grams. Thus, it should be understood that although the present invention has been specifically disclosed by representative embodiments and optional features, modification and variation of the concepts herein disclosed may be resorted to by those skilled in the art, and such modifications and variations are considered within the scope of this invention.

Embodiments of the invention are set forth in the claim(s) that follows(s).

What is claimed is:

1. A method for amplifying a nucleic acid in a sample, the sample containing at least a first and a second nucleic acid species, wherein the first species has a higher copy number than the second species, comprising the steps of:
a) in a reaction vessel annealing to the first nucleic acid species a first amplification primer that is substantially specific for the first nucleic acid species, wherein the first primer has a first concentration; and
b) in the reaction vessel annealing to the second nucleic acid species a second amplification primer that is substantially specific for the second nucleic acid species, wherein the second primer has a second concentration and wherein the second concentration of the second amplification primer is greater than the first concentration of the first amplification primer; and
c) in the reaction vessel annealing to the first and to the second nucleic acid species another amplification primer that can be common to the first and second nucleic acid species, and that is substantially specific for the first and second nucleic acid species; and
d) in the reaction vessel performing a nucleic acid amplification reaction, whereby the quantity of the amplification product of the second nucleic acid species is increased relative to the quantity of the amplification product of the first nucleic acid species.

2. The method of claim 1 further comprising the step of detecting the amplification product of the first nucleic acid species.

3. The method of claim 1 further comprising the step of detecting the amplification product of the second nucleic acid species.

4. The method of claim 1 further comprising the steps of: a) of detecting the amplification product of the first nucleic acid species; and b) detecting the amplification product of the second nucleic acid species; and c) comparing the identity of the first nucleic acid species to the identity of the second nucleic acid species.

5. The method of claim 4 wherein the detection is performed by mass spectrometry.

6. The method of claim 1 further comprising the steps of: a) of quantifying the amplification product of the first nucleic acid species; and b) quantifying the amplification product of the second nucleic acid species; and c) comparing the quantity of the amplification product of the first nucleic acid species to the quantity of the amplification product of the second nucleic acid species.

7. The method of claim 6 wherein the quantification is performed by mass spectrometry.

8. The method of claim 1 wherein the first nucleic acid species is of maternal origin and the second nucleic acid species is of fetal origin.

9. The method of claim 1 wherein the first nucleic acid species has a first nucleic acid-base methylation pattern and the second nucleic acid species has a second nucleic acid-base methylation pattern, and the first nucleic acid-base methylation pattern differs from the second nucleic acid-base methylation pattern.

10. The method of claim 9 wherein the first and second primers are methylation-specific amplification primers.

11. A method for amplifying a nucleic acid in a sample, the sample containing at least a first and a second nucleic acid species, wherein one of the species has a higher copy number than the other species, comprising the steps of:
a) in a first reaction vessel, annealing to the first nucleic acid species a first amplification primer that is substantially specific for the first nucleic acid species, wherein the first primer has a first concentration; and
b) in the first reaction vessel annealing to the second nucleic acid species a second amplification primer that is substantially specific for the second nucleic acid species, wherein the second primer has a second concentration and wherein the second concentration of the second amplification primer is greater than the first concentration of the first amplification primer; and
c) in the first reaction vessel annealing to the first and to the second nucleic acid species another amplification primer that can be common to the first and second nucleic acid species, and that is substantially specific the first and second nucleic acid species, and performing a nucleic acid amplification reaction, whereby if the first species has the higher copy number, then the amplification product of the second nucleic acid species is increased relative to the amplification product of the first nucleic acid species; and
d) in a second reaction vessel annealing to the first nucleic acid species the first amplification primer, wherein the first amplification primer is present at the same concentration as the second concentration of step b; and
e) in the second reaction vessel annealing to the second nucleic acid species the second amplification primer, wherein the second amplification primer is present at the same concentration as the first concentration of step a, whereby the concentration of the first amplification primer is greater than the concentration of the second amplification primer; and
f) in the second reaction vessel annealing to the first and to the second nucleic acid species another amplification primer, which can be common to the first and second nucleic acid species, and performing a nucleic acid amplification reaction, whereby if the second species has the higher copy number, then the amplification product of the first nucleic acid species is increased relative to the amplification product of the second nucleic acid species.

12. The method of claim 11 further comprising the step of detecting the amplification product of the first nucleic acid species.

13. The method of claim 11 further comprising the step of detecting the amplification product of the second nucleic acid species.

14. The method of claim 11 further comprising the steps of: a) of detecting the amplification product of the first nucleic acid species of step a of claim 11; and b) detecting the amplification product of the second nucleic acid species of step b of claim 11; and c) comparing the identity of the first nucleic acid species of step a of claim 11 to the identity of the second nucleic acid species of step b of claim 11.

15. The method of claim 14 wherein the detection is performed by mass spectrometry.

16. The method of claim 11 further comprising the steps of: a) of detecting the amplification product of the first nucleic acid species of step d of claim 11; and b) detecting the amplification product of the second nucleic acid species of step e of claim 11; and c) comparing the identity of the first nucleic acid species of step d of claim 11 to the identity of the second nucleic acid species of step e of claim 11.

17. The method of claim 16 wherein the detection is performed by mass spectrometry.

18. The method of claim 11 further comprising the steps of:
a) detecting the amplification product of the first nucleic acid species of step a of claim 11; and
b) detecting the amplification product of the second nucleic acid species of step b of claim 11; and
c) detecting the amplification product of the first nucleic acid species of step d of claim 11; and
d) detecting the amplification product of the second nucleic acid species of step e of claim 11; and
e) comparing the identities of the first and second nucleic acid species of steps a and b of claim 11 to the identities of the first and second nucleic acid species of steps d and e of claim 11.

19. The method of claim 11 further comprising the steps of: a) of quantifying the amplification product of the first nucleic acid species of step a of claim 11; and b) quantifying the amplification product of the second nucleic acid species of step b of claim 11; and c) comparing the quantity of the amplification product of the first nucleic acid species of step a of claim 11 to the quantity of the amplification product of the second nucleic acid species of step b of claim 11.

20. The method of claim 11 further comprising the steps of: a) of quantifying the amplification product of the first nucleic acid species of step d of claim 11; and b) quantifying the amplification product of the second nucleic acid species of step e of claim 11; and c) comparing the quantity of the amplification product of the first nucleic acid species of step d of claim 11 to the quantity of the amplification product of the second nucleic acid species of step e of claim 11.

21. The method of claim 11 further comprising the steps of:
a) quantifying the amplification product of the first nucleic acid species of step a of claim 11; and
b) quantifying the amplification product of the second nucleic acid species of step b of claim 11; and
c) quantifying the amplification product of the first nucleic acid species of step d of claim 11; and
d) quantifying the amplification product of the second nucleic acid species of step e of claim 11; and
e) comparing the quantities of the amplification products of the first and second nucleic acid species of steps a and b of claim 11 to the quantities of the amplification products of the first and second nucleic acid species of steps d and e of claim 11.

22. The method of claim 11 wherein the first nucleic acid species is of maternal origin and the second nucleic acid species is of fetal origin.

23. The method of claim 11 wherein the first nucleic acid species has a first nucleic acid-base methylation pattern and the second nucleic acid species has a second nucleic acid-base methylation pattern, and the first nucleic acid-base methylation pattern differs from the second nucleic acid-base methylation pattern.

24. The method of claim 23 wherein the first and second primers are methylation-specific amplification primers.

25. A method for detecting the identity of a target nucleic acid present in a sample which also contains non-target nucleic acid, wherein the target and non-target nucleic acids have a greater and lesser copy number, said method comprising the steps of:
a) preparing a first reaction mixture comprising the sample of nucleic acids, a target amplification primer substantially specific for the target nucleic acid, a non-target amplification primer substantially specific for the non-target nucleic acid, and a third amplification primer substantially specific for both target and non-target nucleic acid, wherein the target amplification primer is at a low concentration relative to the non-target amplification primer; and
b) preparing a second reaction mixture comprising the sample of nucleic acids, a target amplification primer substantially specific for the target nucleic acid, a non-target amplification primer substantially specific for the non-target nucleic acid, and a third amplification primer substantially specific for both target and non-target nucleic acid, wherein the target amplification primer is at a high concentration relative to the non-target amplification primer; and
c) amplifying the first and second reaction mixtures to obtain a first set of amplification products and a second set of amplification products, wherein the first set of amplification products are distinguishable from the second set of amplification products.

26. The method of claim 25 further comprising the step of comparing the first set of amplification products to the second set of amplification products, whereby the lesser copy number may be assigned to either the target or non-target nucleic acid.

27. The method of claim 25 further comprising the step of comparing the first set of amplification products to the second set of amplification products, whereby the genotype of the target nucleic acid is determined.

28. The method of claim 1 wherein the sample contains at least a third and a fourth nucleic acid species, wherein the third species has a higher copy number than the fourth species further comprising the steps of:
e) in the same reaction vessel of steps a)-d) annealing to the third nucleic acid species a third nucleic acid species amplification primer that is substantially specific for the third nucleic acid species, wherein the third primer has a third concentration; and
f) in the same reaction vessel of steps a)-d) annealing to the fourth nucleic acid species a fourth amplification primer that is substantially specific for the fourth nucleic acid species, wherein the fourth primer has a fourth concentration and wherein the fourth concentration of the fourth amplification primer is greater than the third concentration of the third amplification primer; and
g) in the same reaction vessel of steps a)-d) annealing to the third and to the fourth nucleic acid species another amplification primer that can be common to each of the third and fourth nucleic acid species, and that is substantially specific for the third and fourth nucleic acid species; and
d) in the same reaction vessel of steps a)-d) performing a nucleic acid amplification reaction, whereby the quantity of the amplification product of the third nucleic acid species relative to the quantity of the amplification product of the fourth nucleic acid species is increased.

29. The method of claim 11 wherein the sample contains at least a third and a fourth nucleic acid species, wherein the third species has a higher copy number than the fourth species further comprising the steps of:
g) in the same first reaction vessel of steps a)-c) annealing to the third nucleic acid species a third nucleic acid species amplification primer that is substantially specific for the third nucleic acid species, wherein the third primer has a third concentration; and
h) in the same first reaction vessel of steps a)-c) annealing to the fourth nucleic acid species a fourth amplification primer that is substantially specific for the fourth nucleic acid species, wherein the fourth primer has a fourth concentration and wherein the fourth concentration of the fourth amplification primer is greater than the third concentration of the third amplification primer; and
i) in the same first reaction vessel of steps a)-c) annealing to the third and to the fourth nucleic acid species another amplification primer that can be common to each of the third and fourth nucleic acid species, and that is substantially specific for the third and fourth nucleic acid species, and performing a nucleic acid amplification reaction, whereby if the third species has the higher copy number, then the amplification product of the fourth nucleic acid species relative to the amplification product of the third nucleic acid species is increased; and
j) in the same second reaction vessel of steps d)-f) annealing to the third nucleic acid species the third amplification primer, wherein the third amplification primer is present at the same concentration as the fourth concentration of step h; and
k) in the same second reaction vessel of steps d)-f) annealing to the fourth nucleic acid species the fourth amplification primer, wherein the fourth amplification primer is present at the same concentration as the third concentration of step g, whereby the concentration of the third amplification primer is greater than the concentration of the fourth amplification primer; and
l) in the same second reaction vessel of steps d)-f) annealing to the third and to the fourth nucleic acid species another amplification primer, which can be common to the third and fourth nucleic acid species, and performing a nucleic acid amplification reaction, whereby if the fourth species has the higher copy number, then the amplification product of the third nucleic acid species is increased relative to the amplification product of the fourth nucleic acid species.

30. The method of claim 1 further comprising the steps of:
e) in a second reaction vessel annealing to the first nucleic acid species a first amplification primer that is substantially specific for the first nucleic acid species, wherein the first primer has a first concentration; and
f) in the second reaction vessel annealing to the second nucleic acid species a second amplification primer that is substantially specific for the second nucleic acid species, wherein the second primer has a second concentration and wherein the second concentration of the second amplification primer is equal to the first concentration of the first amplification primer; and
g) in the second reaction vessel annealing to the first and to the second nucleic acid species another amplification primer that can be common to the first and second nucleic acid species, and that is substantially specific for the first and second nucleic acid species.

31. The method of claim 11 further comprising the steps of:
g) in a third reaction vessel annealing to the first nucleic acid species a first amplification primer that is substantially specific for the first nucleic acid species, wherein the first primer has a first concentration; and
h) in the third reaction vessel annealing to the second nucleic acid species a second amplification primer that is substantially specific for the second nucleic acid species, wherein the second primer has a second concentration and wherein the second concentration of the second amplification primer is equal to the first concentration of the first amplification primer; and
i) in the third reaction vessel annealing to the first and to the second nucleic acid species another amplification primer that can be common to the first and second nucleic acid species, and that is substantially specific for the first and second nucleic acid species.
